(19) United States
(12) Patent Application Publication
(10) Pub. No.: US 2006/0257593 A1
(43) Pub. Date: Nov. 16, 2006

(54) Coated printing sheet and process for making same

(76) Inventor: J P Haenen, GASCOGNE 8, NI-6245 PP EUSDEN (NL)

Correspondence Address: Abelman Frayne & Schwab, 150 East 42nd Street, New York, NY, 10017-5612, US

(21) Appl. No.: 10/530,084

(22) PCT Filed: Sep. 30, 2003
(86) PCT No.: PCT/EP03/10816

§ 371 Date: Mar. 2, 2006

(30) Foreign Application Priority Data
Oct. 1, 2002 (EP) 02022030.7
Apr. 15, 2003 (EP) 03405263.9

(51) Int. Cl. B41M 5/00

(52) U.S. Cl. 428/32.34

(57) ABSTRACT

A printing sheet is described comprising a substrate and, on at least one side of the substrate, an image receptive coating layer with a cumulative porosity volume of pore widths below 200 nm as measured using nitrogen intrusion methods of more than 0.006 cm³ per gram paper. In particular in the context of printing sheets with high-gloss this particular porosity distribution leads to a quick and easily adjustable ink setting behaviour. Additionally a method for manufacturing such a printing sheet is described using organic, i.e. polymer and inorganic particulate pigments of fine particle characteristics.

### TECHNICAL FIELD

The present invention relates to a printing sheet comprising a substrate and, on at least one side of the substrate, an image receptive coating layer. It additionally relates to a method of manufacturing as well as to a use of such a printing sheet.

### BACKGROUND OF THE INVENTION

In particular in the field of high-quality of offset printing e.g. in artistic reproductions and glossy journals etc., paper is needed which shows high gloss, is easily printable, has quick ink drying behaviour and at the same time has a high bulk and stiffness, i.e. which has a low density.

In the manufacturing of such a paper, the finishing operation is usually a calendering process, in which a paper web is passed between the nips formed between one or more pairs of rolls and the surface of the web is thereby flattened to form a smooth and glossy surface. Simultaneously, the thickness of the paper web is reduced and the web is densified. Calendering generally increases the density, and the finished paper product in turn shows less stiffness as the internal structure of the paper is partially collapsed. Bulk is inversely related to density, so when the density increases in the calendering process, the bulk of the finished paper product will correspondingly be reduced.

Calendering may generally be accomplished using a gloss calender, (two roll) soft calender, a (multiroll) supercalender or a multinip calender (e.g. Janus). The gloss calender is typically comprised of a hard, non-resilient, heated roll made, for example, of steel, positioned proximally to a soft roll so as to form a nip. As the web passes through the nip it is exposed to a nip load in the range of about 20 to 80 kN/m and a temperature range of 120-150 degrees Celsius. A wider range of pressures and temperatures can be used in a soft calender or supercalender, with the usual pressure being in the range of 150-450 kN/m and the maximum temperature being in the range of about 220-230 degrees Celsius. The higher temperature produces a superior gloss finish on the surface of the web as it is passed through the nip, while the lower pressure used in a gloss calender causes less densification of the web, in comparison to a conventional supercalender. The finishing effect achieved using a gloss calender, however, is not as smooth or as flat, and therefore not as glossy, as the surface produced using an apparatus capable of applying higher pressure. It is therefore often useful to increase the nip load or the roll temperature, or both, to additionally plasticize and smooth the surface layers of the paper. Such modifications are incorporated, for example, in the design and operation of the conventional soft calender or supercalender. The soft calender is usually constructed as having one to two nips per coated side, with each nip being formed between a heated hard roll and an unheated soft roll. In a supercalender the number of rolls is as high as 9-12, inherently giving more nips.

Alternatively, a multinip calender (e.g. Janus type) may be used as the finishing operation. The rolls of the supercalender may be steam heated hard rolls or unheated soft rolls, in serial or alternating arrangement. The nips formed between the rolls are typically shorter than those of a soft calender or gloss calender. In such a multinip calender, the web is compressed to form paper of substantially uniform density and high gloss by virtue of the repeated pressurization and heat exposure. Typical nip pressures are 100-250 kN/m and temperatures of the heated roll up to about 150 degree Celsius. The high pressure however also causes, as mentioned above, a corresponding reduction in bulk.

There is therefore an inherent conflict between the calendering necessary for achieving a particular gloss and the bulk properties of the paper. The less pressure applied in the calendering process, the lower the achievable gloss and at the same time the higher the bulk. If, on the other hand, high gloss is achieved by applying high pressure in the calendering process, bulk is lost.

Calendering is not the only possibility to achieve gloss on the surface of a printing sheet. It is known in the papermaking art that various coating formulations and coating ingredients may be used in the manufacture of paper to achieve high gloss. For example, U.S. Pat. No. 5,283,129 discloses a lightweight paper stock that is coated with a pigment composition including delaminated clay, calcined clay and titanium dioxide, wherein up to about 5 parts by weight of hollow core opacifying plastic pigment may be used. U.S. Pat. No. 4,010,307 discloses a high gloss coated paper product comprising 10-95% calcium carbonate and from 5-30% by weight of a non-film forming polymeric pigment having particles sized within the range of from 0.0000495-0.000297 mm (0.05-0.30 microns). U.S. Pat. No. 5,360,657 discloses a high gloss paper prepared by a process wherein a thermoplastic polymeric latex having a second order glass transition temperature of at least about 80° C., and an average particle size smaller than 0.099 mm (100 microns), is applied to paper that is subsequently calendered. WO 98/20201 discloses a printing paper having high brightness and gloss manufactured by applying to paper a coating comprising at least 80 parts precipitated calcium carbonate and at least 5 parts of an acrylic styrene copolymer hollow sphere plastic pigment, based on 100 parts total weight of pigment, before finishing the coated paper to achieve gloss development. The finishing process does not involve using a modified supercalender, and the resulting paper is not thought as being a high bulk product. Hollow sphere pigments have also been used to produce a non-gloss finish. Also EP 1186707 A2 describes a glossy paper with hollow sphere organic pigments.

Usually, the use of gloss enhancing components or the application of gloss enhancing treatment slows down setting of the ink in the subsequent offset printing process.

Therefore, not only gloss and bulk are important properties of such a printing sheet, but also the ink setting properties. To achieve good runnability and printability of the sheet, it is desirable to have rather quick ink setting in a particular range. If the ink setting is too fast, the tacky ink has the tendency to get absorbed into the paper too quickly leading e.g. to problems associated with lifting off surface parts of the paper during the printing process (breaking of the cohesion within the printing sheet, known in the field as picking), mottling or too low printing gloss values. On the other hand, if the ink setting is too slow, too much time has to be allowed for drying of the ink and correspondingly the printing speed has to be reduced. Therefore a need exists for printing sheets as well as a method of manufacturing such printing sheets (also paperboard products) which show high bulk and ink setting characteristics which can be easily adjusted and allow quick ink setting. At the same time, usually the finished product may have a high gloss surface, but also dull or matte papers of this kind, i.e. showing high bulk and adjustable ink setting behaviour, are of interest.

### SUMMARY OF THE INVENTION

The objective problem underlying the present invention is therefore to make available, a printing sheet as well as a method for manufacturing such a printing sheet, that provides adjustable ink setting behaviour and allows quick ink setting, while at the same time shows high bulk and if required high gloss. The ink setting behaviour shall be adjustable to comply with particular needs as arising in the printing process.

The present invention solves the above problem by providing a very particular porosity structure of the image receptive layer of the printing sheet. A printing sheet is provided comprising a substrate and, on at least one side of the substrate, an image receptive coating layer. Characteristic is that the printing sheet shows a cumulative porosity volume of pore widths below 200 nm of more than 0.006 cm³ per gram paper. The porosity is measured using standard liquid nitrogen intrusion methods on the surface of the image receptive coating layer. The substrate mentioned may be pre-coated or not, and it may be a wood-free or mechanical coated base stock, and may optionally be partially or fully synthetic.

The object of the present invention is therefore a printing sheet according to claim 1, a method for its manufacture according to claim 29 and a use of the printing sheet according to claim 44.

The key feature of the invention is the finding that the very particular structure of the porosity, i.e. the provision of an additional large cumulative pore volume at small pore; sizes of less than 200 nm (especially below about 100 nm), provides the necessary capillary forces and storage volume to allow fast ink setting, i.e. removal of the ink pigment accompanying liquid components from the surface of the printing sheet into the interior immediately after the application of the ink to the paper surface. These characterizing data are exemplified for a paper of approximately 115 g/m² paperweight. The absolute values of the cumulative pore volume below a certain threshold will approximately scale accordingly depending on the paperweight considered. Given that the fibrous part does not contribute significantly to the above mentioned nano-porosity and that the image receptive layer is substantially identical (composition, thickness), a paper of twice the above-mentioned paperweight will correspondingly show half of the cumulative porosity volume in cm³ per gram paper. In absolute values, i.e. independent of the paperweight in g/m², the above figures now expressed in cumulative porosity volume per m² of paper, would be as follows: a cumulative porosity volume of pore widths below 200 nm of more than 0.69 cm³/m², these figures now being largely independent of the paperweight under the above-mentioned assumptions. Such a coating can be present on one side of the substrate, or on both sides.

In a first preferred embodiment of the present invention the cumulative porosity volume of pore widths below 200 nm is more than 0.008 cm³ per gram paper. This for a paper of 115 g/m² paperweight. Again expressed alternatively in a tentative absolute number, that would mean cumulative porosity volume of pore widths below 200 nm of more than approximately 0.92 cm³/m². The porosity structure can alternatively also be defined as providing a cumulative porosity volume of pore widths below 150 nm of more than 0.004 cm³ per gram paper or alternatively in absolute value a cumulative porosity volume of pore widths below 150 nm of more than 0.46 cm³/m². Typically such a paper has a paperweight of in the range of 80 to 400 g/m², preferentially of 90 or 100 to 250 g/m².

To effectively adjust the ink setting behaviour of such an image receptive coating, the polarity of this internal porous surface must be controlled. The ink setting is to be adjusted such as to allow the freshly printed sheet to be almost immediately further processed or printed on the other side (so called perfecting). For example it should be possible to print the second side after the usual time necessary for handling, i.e. after 10 to 15 minutes. Ink setting is quantified as ink set-off values for given times e.g. by using a Skinnex 800 analyzer. For fast ink setting, the surface of the image receptive coating layer is preferentially non-polar (high dispersive part of the surface energy), as then the overall non-polar offset ink oils are not repelled by the surface and are effectively transported into the pores assisted by capillary forces. The polarity of the surface can be adjusted by adding corresponding components to the coating composition, which components modify the hydrophobic character of the surface. Typically the ink setting can be adjusted to show an ink set-off of less than 0.3 at 30 secs, preferably of in the range of between 0.15 to 0.25 at 30 seconds. This is possible substantially without substantially modifying the porosity structure in the above-mentioned region of pores smaller than 200 nm. Fast ink-setting in combination with low sensitivity back trap mottle and ink refusal is realized by simultaneously creating a fine pore structure and making the surface more polar.

Examples of such components shall be given below. Advantageously, the polar part of the surface energy of the surface of the image receptive coating layer is less than 7 mN/m, preferably less than 6 mN/m as determined by contact angle measurements, at a Parker Print Surf (PPS) surface roughness of 0.8 to 1 μm, preferably of less than 0.9 μm. However, with the given porous structure, the polar part of the surface energy should preferentially also not be too low, such as to prevent the ink to be absorbed into the paper too quickly and too effectively by the capillary forces provided by the tubes. Correspondingly, the polar part of the surface energy should preferentially not be lower than 4 mN/m.

Normally, such a printing sheet is characterised by a gloss on the surface of the image receptive coating of more than 75% according to TAPPI 75 deg. Alternatively or additionally, it is characterised by a gloss on its surface of more than 45%, preferably more than 50% according to DIN 75 deg. Lower gloss is also possible.

As mentioned above, such papers can be produced at high bulk, typically such a paper has a specific volume of more than 0.80 cm³/g, preferably of more than 0.82 or 0.85 cm³/g. This is due to the fact that little calendering is necessary for achieving any given gloss thus preserving the bulk properties. Generally speaking, the fibre composition of the uncoated substrate should preferentially be such that the specific volume before calendering is more than 0.88 cm³/g, typically more than 0.90 or 0.92 cm³/g. Normally, the non-fibre content of the substrate is between 40% and 50% for papers up to 170 gm² and between 30% to 40% for papers of higher weights.

According to another preferred embodiment of the present invention, such a printing sheet is characterised in that the image receptive coating layer has a top layer comprising: a pigment part, wherein this pigment part is composed of a) 50 to 100 parts in dry weight of a fine particulate carbonate with a particle size distribution such that more than 80% of the particles are smaller than 1 μm, preferably with a particle size distribution such that approximately 90% of the particles are smaller than 1 μm, b) 0 to 50 parts in dry weight of a fine particulate kaolin with a particle size distribution such that more than 90% of the particles are smaller than 1 μm preferably with a particle size distribution that more than 95% of the particles are smaller than 1 μm, c) 0 to 20 parts in dry weight of a particulate, preferably solid (but also a vacuolated pigment is possible) polymer pigment with a particle size distribution such that more than 90% of the particles are smaller than 0.5 μm, preferably with a particle size distribution such that 90% of the particles have sizes between 0.05 and 0.3 μm, in particular between 0.1 and 0.2 μm. Additionally, a binder part is present in the top layer, wherein this binder part is composed of: a) less than 12 to 16 parts in dry weight of binder and b) less than 2 parts in dry weight of additives. It is the special choice of fine pigment particles of particular size distributions in combination with the correct binder composition that allows the establishment of the above-mentioned, highly effective porosity structure. It has to be understood that the above-mentioned composition is substantially exclusive, i.e. it substantially only contains the mentioned components, so for example the pigment part is formed by the components a), b) and c), and there is no other pigment in substantial amounts present, be it inorganic or organic pigment. It is also possible to replace component a) substantially by amounts of c), i.e. it is possible to have e.g. only 20 to 40 parts of a), 0 to 40 parts of b) and 50 to 80 parts of c). It is thus possible to e.g. replace basically the whole inorganic pigment part by the particulate pigment. Possible are ranges of particulate pigment between 2 and 100% of the whole pigment part of the coating, in particular preferably 50-100%. However, care has to be taken in this case with the choice of the polymer pigment, as high amounts of the pigment or unsuitable pigment can cause burnishing of the paper. Burnishing is a phenomenon where localized areas of increased gloss or reflectivity on the surface of the sheet are caused e.g. by mechanical rubbing and the associated increased density of the top layer in this region. More specifically, preferentially the pigment part of the top layer comprises: a) 60 to 100 parts in dry weight, preferably 65 to 80 parts in dry weight of a fine particulate calcium carbonate with a particle size distribution such that approximately 90% of the particles are smaller than 1 μm, b) 10 to 40 parts in dry weight, preferably 15 to 30 parts in dry weight of a fine particulate kaolin with a particle size distribution such that 95% of the particles are smaller than 1 μm, c) 10 to 15 parts in dry weight of a solid particulate or vacuolated polymer pigment with a particle size distribution centred at approximately 0.13 to 0.17 μm, preferably centred at approximately 0.14 μm, wherein 95% of the particles are located within+/−0.03 μm of this mean particle size. Also mixtures of polymer particles of different size are possible. If a vacuolated pigment is chosen, also higher mean particle sizes of in the range of 0.1 to 0.8 μm are possible, like e.g. in the range of 0.6 μm. Additionally, in case of such vacuolated particulate polymer pigments, preferably 8-30 parts in dry weight are used. The solid particulate polymer pigment is preferentially selected from the group consisting of: poly(methyl methacrylate), poly(2-chloroethyl methacrylate), poly(isopropyl methacrylate), polyphenyl methacrylate), polyacrylonitrile, polymethacrylonitrile, polycarbonates, polyetheretherketones, polyimides, acetals, polyphenylene sulfides, phenolic resins, melamine resins, urea resins, epoxy resins, polystyrene latexes, polyacrylamides, and alloys, blends, mixtures and derivatives thereof. Possible are also Styrene maleic acid copolymeric latexes (SMA) or styrene malimide copolymeric latexes (SMI), mixtures of these with the above mentioned structures and derivatives thereof. This particularly preferred embodiment, SMA or SMI or mixtures thereof, is preferably adjusted to have a high T_{G}-value of close to 200° C. This means that SMI is the major constituent, i.e. normally the content of SMI is above 80%, or even above 90% or 95% (T_{G} (SMI)=202° C.). Also particulate solid polymer pigments consisting of substantially 100% SMI are possible. The particularly high hardness of SMI in conjunction with the hydrophobic character make these pigments useful also for high contents of particulate polymer pigment, i.e. if up to 100% of the pigment part consist of the polymer pigment. It seems to be particularly effective to use a modified polystyrene latex for the solid pigment particles of the above-mentioned particular size distribution.

As mentioned above, the binder part is of importance with respect to the adjustment of the ink set-off behaviour of the printing sheet. Accordingly, the binder part of the top layer preferentially comprises: a′) a binder selected from the group consisting of latex, in particular styrene-butadiene, styrene-butadiene-acrylonitrile, styrene-acrylic, styrene-butadiene-acrylic latexes, starch, polyacrylate salt, polyvinyl alcohol, soy, casein, carboxymethyl cellulose, hydroxymethyl cellulose and mixtures thereof, b′) additives like defoamers, colorants, brighteners, dispersants, thickeners, water retention agents, preservatives, crosslinkers, lubricants and pH control agents etc. It was found out to be very effective if the binder is an acrylic ester copolymer based on butylacrylate, styrene and acrylonitrile. Usually such binders are provided as dispersions of a polymer. Such a binder is for example available on the market under the name Acronal 360D by BASF, DE. Typically, 10 to 16 parts in dry weight, preferably 11 to 14 or 12 to 14 parts in dry weight of binder is present in the binder part. The top layer typically has a total dried coat weight of in the range of 3 to 25 g/m², preferably in the range of 4 to 15 g/m², and most preferably of about 6 to 12 g/m². If the substrate is coated on both sides, these numbers refer to the weight per side.

According to another preferred embodiment of the present invention, the above-mentioned top layer is supported in its function to provide the required porosity structure by a second (porous) layer immediately beneath the top layer. The second layer preferably comprises: a pigment part, wherein this pigment part is composed of A) 50 to 100 parts in dry weight of a fine particulate carbonate with a particle size distribution such that more than 80% of the particles are smaller than 1 μm, preferably with a particle size distribution such that approximately 90% of the particles are smaller than 1 μm, B) 0 to 50 parts in dry weight of a fine particulate kaolin with a particle size distribution such that more than 50% of the particles are smaller than 1 μm, preferably with a particle size distribution that more than 60% of the particles are smaller than 1 μm, and a binder part, wherein this binder is composed of: A′) less than 20 parts in dry weight of binder and B′) less than 4 parts in dry weight of additives. So also the second layer shows a very particular and fine pigment structure, which in a synergy supports and enhances the function of the top layer. The component B may also be replaced by some calcium carbonate with good coverage properties, i.e. which is able to substitute the kaolin. Like that it is possible to save costs and to increase the brightness of the resulting paper. Possible is a ground calcium carbonate of the type like Covercarb 75, i.e. e.g. with a particle size distribution such that more than 70% of the particles are smaller than 1 μm. In case of such replacement of the kaolin by a fine particulate carbonate, it proves advantageous to use approx. the same amount (in weight) of the fine particulate carbonate of type A) as well as of type B). Advantageously, the pigment part of the second layer comprises A) 70 to 90 parts in dry weight, preferably approx. 75 parts in dry weight of a fine particulate calcium carbonate with a particle size distribution such that approximately 90% of the particles are smaller than 1 μm, B) 20 to 40 parts in dry weight, preferably approx. 25 parts in dry weight of a fine particulate kaolin with a particle size distribution such that 65% of the particles are smaller than 1 μm. As concerns the binder part of the second layer, it typically comprises A′) a binder, usually provided in the form of a dispersion of the polymer in water for the application of the coating, selected from the group consisting of latex, in particular styrene-butadiene, styrene-butadiene-acrylonitrile, styrene-acrylic, styrene-butadiene-acrylic latexes, starch, polyacrylate salt, polyvinyl alcohol, soy, casein, carboxymethyl cellulose, hydroxymethyl cellulose and mixtures thereof, B′) additives like defoamers, colorants, brighteners, dispersants, thickeners, water retention agents, preservatives, crosslinkers, lubricants and pH control agents etc. Advantageously, the binder is a styrene butadiene copolymer, as it is for example available under the trade name Rhodopas SB 083 in the form of a 50% dispersion by Rhodia, FR. Typically, 6 to 20 parts in dry weight, preferably 8 to 14 parts in dry weight, and most preferably approximately 10 parts in dry weight of binder is present in the binder part of the second layer. To have an optimum effect together with the top layer, the second layer has a total dried coat weight of in the range of 5 to 25 g/m², preferably in the range of 8 to 20 g/m². If the substrate is coated on both sides, these numbers refer to the weight per side.

According to a still further preferred embodiment of the present invention, there is provided an additional, third layer beneath the above-mentioned second layer. This third layer is composed of: a pigment part, wherein this pigment part is composed of AA) 50 to 100 parts in dry weight of a particulate carbonate with a particle size distribution such that more than 70% of the particles are smaller than 1 μm preferably with a particle size distribution such that approximately or more than 80% of the particles are smaller than 1 μm, and a binder part, wherein this binder is composed of: AA′) less than 10 parts in dry weight of binder and BB′) less than 4 to 6 parts in dry weight of additives. Preferably the fraction AA is made of approx. 70% of a particulate carbonate with a particle size distribution such that approximately 80% of the particles are smaller than 1 μm and approx. 30% of a particulate carbonate with a particle size distribution such that approximately 50% of the particles are smaller than 1 μm.

Further embodiments of the printing sheet according to the present invention are described in the dependent claims.

The present invention also relates to a method of manufacturing a printing sheet comprising the following steps: dd) applying an image receptive top layer on the substrate said top layer comprising: a pigment part, wherein this pigment part is composed of a) 50 to 100 parts in dry weight of a fine particulate carbonate with a particle size distribution such that more than 80% of the particles are smaller than 1 μm, preferably with a particle size distribution such that approximately 90% of the particles are smaller than 1 μm, b) 0 to 50 parts in dry weight of a fine particulate kaolin with a particle size distribution such that more than 90% of the particles are smaller than 1 μm, preferably with a particle size distribution that more than 95% of the particles are smaller than 1 μm, c) 0 to 10 parts in dry weight of a particulate, preferably solid polymer pigment with a particle size distribution such that more than 90% of the particles are smaller than 0.5 μm, preferably with a particle size distribution such that 90% of the particles have sizes between 0.05 and 0.3 μm, in particular between 0.1 and 0.2 μm, and a binder part, wherein this binder part is composed of: a′) less than 20 parts in dry weight of binder and b′) less than 2 parts in dry weight of additives, ee) drying the image receptive coating layer, ff) calendering at a nip pressure of less than approximately 200 N/mm. Preferred are nip pressures of approximately 110 N/mm. Preferentially, less than 3 or 4 nips are used for calendering. Typically, the top layer has a total dried coat weight of in the range of 3 to 25 g/m² per side, preferably in the range of 4 to 15 g/m² per side, and most preferably of about 6 to 12 g/m² per side, and the mentioned method can advantageously be used for manufacturing a printing sheet as it is described above. Correspondingly, very “soft” calendering conditions are possible at the same time achieving high-gloss as mentioned above, thus preserving the bulk of the paper as well as its stiffness and providing the required porosity structure.

As already mentioned above, a second layer is advantageously provided right beneath the top layer. Accordingly, it is possible to, prior to the application of the top coat layer, to apply: cc) a second layer on the substrate, said second layer beneath said top layer comprising: a pigment part, wherein this pigment part is composed of A) 50 to 100 parts in dry weight of a fine particulate carbonate with a particle size distribution such that more than 80% of the particles are smaller than 1 μm, preferably with a particle size distribution such that approximately 90% of the particles are smaller than 1 μm, B) 0 to 50 parts in dry weight of a fine particulate kaolin with a particle size distribution such that more than 50% of the particles are smaller than 1 μm, preferably with a particle size distribution that more than 60% of the particles are smaller than 1 μm, and a binder part, wherein this binder is composed of: A′) less than 20 parts in dry weight of binder and B′) less than 4 parts in dry weight of additives. Typically, the second layer has a total dried coat weight of in the range of 5 to 25 g/m², preferably in the range of 8 to 20 g/m². Again, if the substrate is coated on both sides, these numbers refer to the weight per side.

As also mentioned above, it is, according to another preferred embodiment of the present invention, advantageous to provide a third layer beneath the second layer. Accordingly, prior to the application of the second layer bb) a third layer is applied on the substrate, said third layer beneath said second layer comprising: AA) 50 to 100 parts in dry weight of a particulate carbonate with a particle size distribution such that more than 70% of the particles are smaller than 1 μm, preferably with a particle size distribution such that approximately or more than 80% of the particles are smaller than 1 μm, and a binder part, wherein this binder is composed of: AA′) less than 10 parts in dry weight of binder and BB′) less than 4 to 6 parts in dry weight of additives. Prior to the application of this third layer or prior to the application of the second layer if this third layer is not present, or prior to the application of the top layer if neither the third nor the second layer is present, it is possible to apply one or several sizing layers to the uncoated substrate. Typically, the resulting printing sheet has a total weight in the range of 80 to 400 g/m², preferentially of 100 to 250 g/m², after the coating and the drying process.

To get the above-mentioned gloss values, it is usually sufficient to apply, in the calendering step (ff), a nip pressure of less than 200 N/mm, preferably in the range of 90 to 110 N/mm. Several rolls can be used in the calendering step, 4 or less are advantageously used.

Further embodiments of the method to manufacture a printing sheet are described in the dependent claims.

Additionally, the present invention relates to the use of a printing sheet as described above in an offset printing process.

### SHORT DESCRIPTION OF THE FIGURES

In the accompanying drawings preferred embodiments of the invention are shown in which:

FIG. 1 shows a partial schematic cut through a coated paper according to the present invention;

FIG. 2 particle size distributions of inorganic particulate carbonates;

FIG. 3 a) particle size distribution of inorganic particulate kaolin, b) particle size distribution of DPP 3710 (solid plastic pigment);

FIG. 4 a) SEM-Picture (40,000×) of example Mill 2
b) SEM-Picture (40,000×) of example Pilot 1.
c) SEM-Picture (40,000×) of example Pilot 2
d) SEM-Picture (40,000×) of example Pilot 3
e) SEM-Picture (40,000×) of the comparative example;

FIG. 5 shows nitrogen intrusion measurements of cumulative pore size distributions of some of the embodiments;

FIG. 6 shows the effect of latex binder content on polar part of the surface energy of the pore system;

FIG. 7 shows the tack development of mineral oil model ink on coated papers, a) samples Mill 1, Mill 2, and Mill 3, b) samples Pilot 1, Pilot 2, Pilot 3, Pilot 4, Pilot 5;

FIG. 8 shows the tack development of biological oil model ink on coated papers, a) samples Mill 1, Mill 2, and Mill 3, b) samples Pilot 1, Pilot 2, Pilot 3, Pilot 4, Pilot 5; and

FIG. 9 cumulative mercury intrusion measurements of all the examples as well as of the comparative example.

### DETAILED DESCRIPTION OF THE PREFERRED EMBODIMENTS

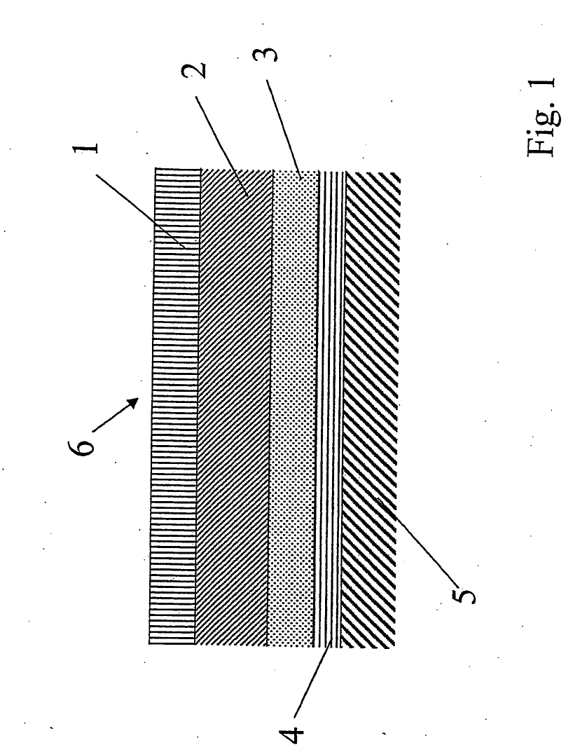

Referring to the drawings, which are for the purpose of illustrating the present preferred embodiments of the invention and not for the purpose of limiting the same, FIG. 1 shows a cut through a paper representing a first example of a printing sheet according to the present invention. The printing sheet comprises a substrate 5, of which only the top part is displayed in FIG. 1. As a first layer on this substrate 5 there is a possibly pigmented sizing layer 4, then follows a third layer 3, a second layer 2 and a top layer 1. FIG. 1 only displays one of the lateral surfaces of the printing sheet, if the printing sheet is coated on both sides, which is usually the case, the structure displayed in FIG. 1 is also present on the bottom part of the printing sheet, the sequence of the layers being a mirror image of the sequence displayed in FIG. 1.

In the following, each of the layers as well as their components shall be described in more detail, the method for manufacturing the paper as well as of the analysis of the properties of the final printing sheet being presented at the end. For the purpose of illustrating the invention, 10 examples are being given as well as one comparative, example, representing a state-of-the-art glossy paper for offset printing. As comparative example, a 115 g/m² glossy paper available under the trade name Magnostar from SAPPI, AT, has been used. 5 Examples have been produced using a pilot coater (Pilot 1-5), and 5 examples have been produced in a mill (Mill 1-6). The 10 examples in particular vary with respect to the composition of the top layer 1, where different proportions of inorganic pigments to organic pigments as well as different compositions of inorganic pigments and different binder contents are compared in particular with respect to ink set-off properties.

Top Layer 1

The various components of the top layer 1 of the 10 examples are listed in table 1. All numbers given are dry or active parts.

TABLE 1
Top layer composition

| | Mill 1 | Mill 2 | Mill 3 | Pilot 1 |
|---|---|---|---|---|
| Pigment part | | | | |
| DPP 3710 | 20 | 10 | 10 | 20 |
| Setacarb HG | 50 | 60 | 60 | 50 |
| Amazon | 30 | 30 | 30 | 30 |
| Binder part | | | | |
| Acronal 360 D | 16 | 11 | 11 | 16 |
| Additives | 0.825 | 1.29 | 1.29 | 0.71 |

| | Pilot 2 | Pilot 3 | Pilot 4 | Pilot 5 | Mill 6 |
|---|---|---|---|---|---|
| Pigment part | | | | | |
| DPP 3710 | 0 | 10 | 10 | 5 | 0 |
| RopaqueBC643 | | | | | 8 |
| Setacarb HG | 70 | 60 | 60 | 65 | |
| Amazon | 30 | 30 | 30 | 30 | 30 |
| VP15 | | | | | 62 |
| Binder part | | | | | |
| Acronal 360 D | 14 | 15 | 12 | 12 | 12 |
| Additives | 0.9 | 0.775 | 1.55 | 1.55 | 2 |

The examples Mill 4 and Mill 5 have the same top layer composition as Mill 2.

Pigment Part:

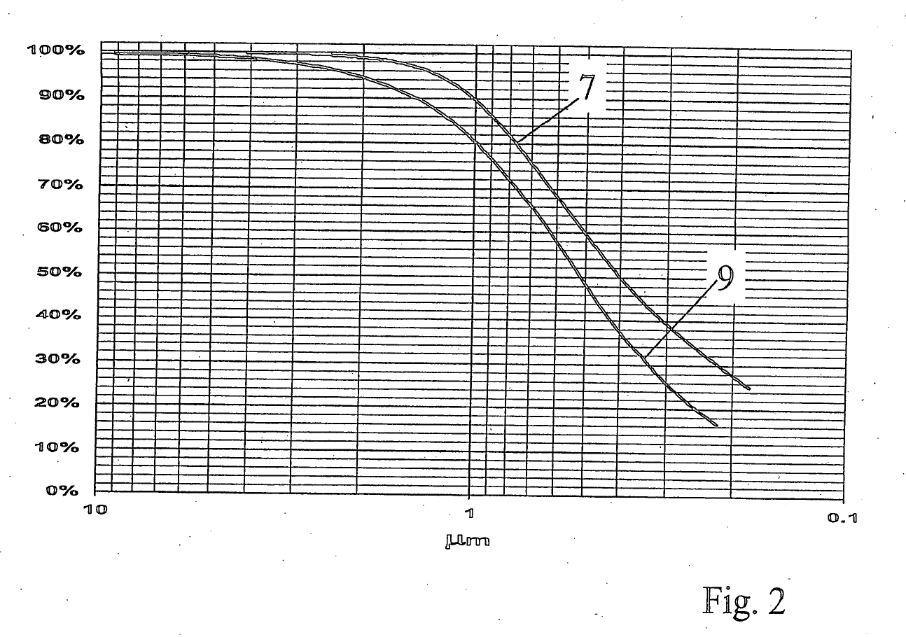

Setacarb HG is a fine ground particulate calcium carbonate inorganic pigment with a characteristic particle size distribution. The particle size distribution of this pigment is displayed in FIG. 2. 7 indicates the distribution of Setacarb HG. One can see that the top layer coatings according to the present invention are characterised by a particularly high content in very fine inorganic pigments, namely of Setacarb HG, which has a distribution such that approximately 90% of the particles are smaller than 1 μm. The very fine particle structure of this inorganic pigment is one of the important features to obtain the porosity structure according to the invention.

Another calcium carbonate pigment that may be used to replace the Setacarb HG is VP15, a fine structured pigment where the small particles adhere to the larger particles. It is available from Omya, AT.

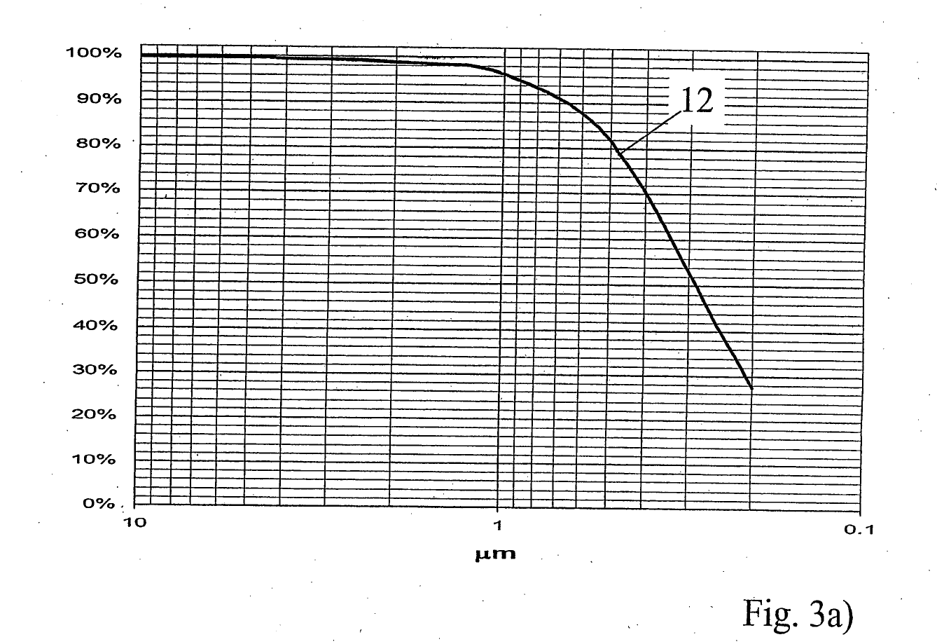

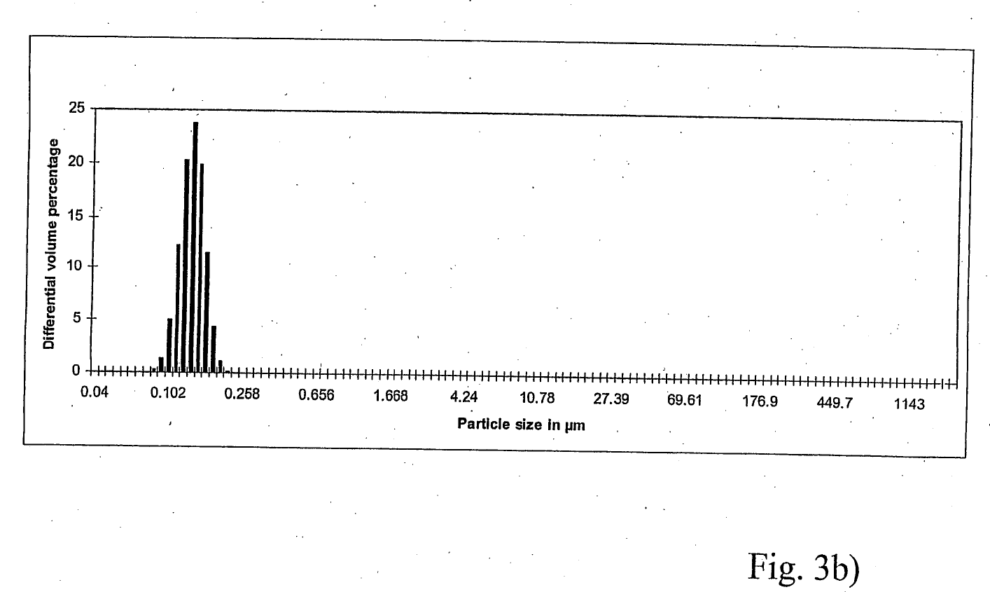

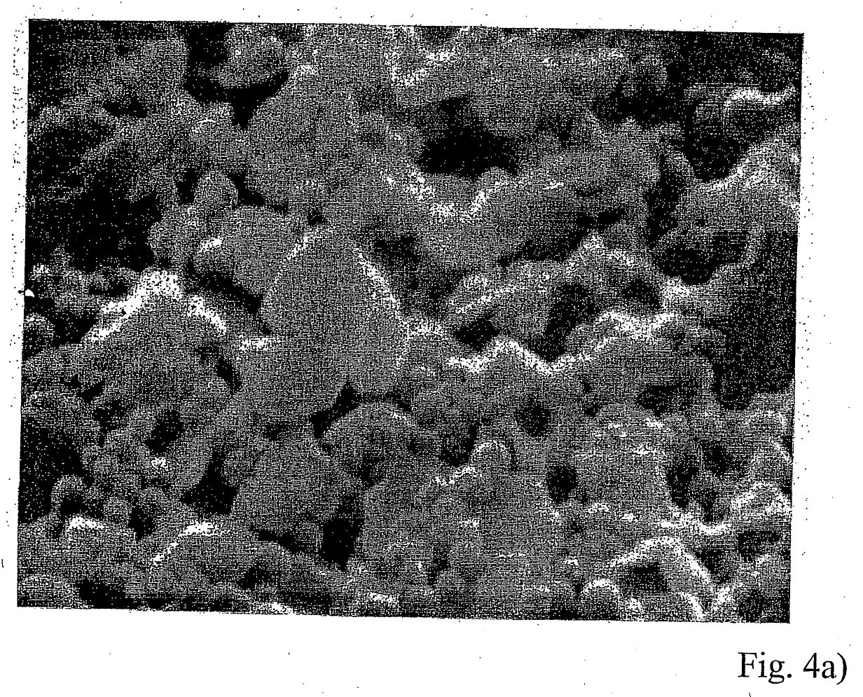

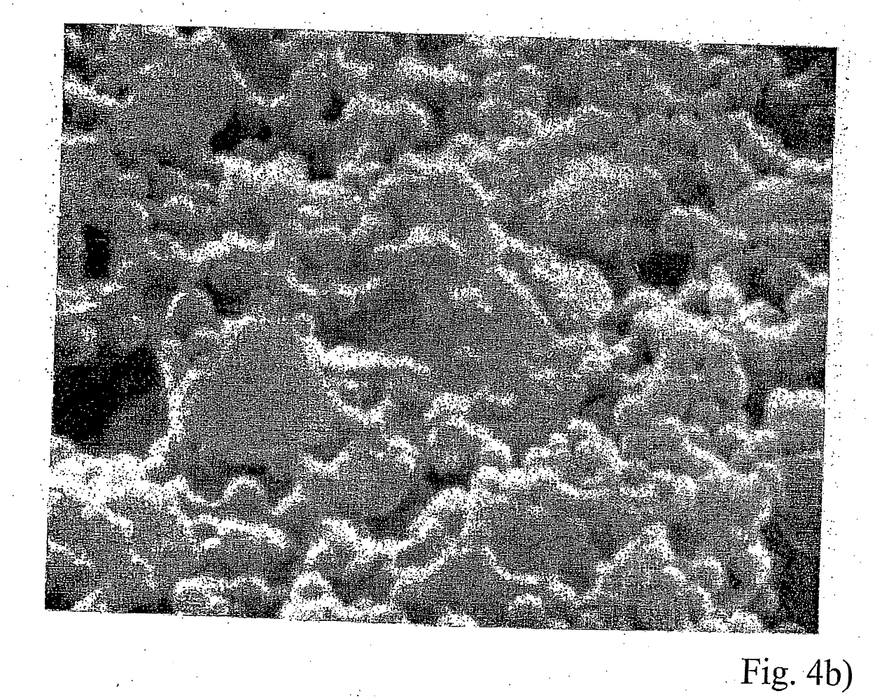

Apart from the calcium carbonate inorganic pigment, there is also fine kaolin present, namely Amazon preferably Amazon 88, Amazon plus or Amazon premium. The particle size distribution of this kaolin is displayed in FIG. 3a). Again, also with respect to the kaolin, the coatings according to the invention are characterised by a particularly high percentage of very fine kaolin.

Additionally, the pigment part comprises an organic pigment, namely DPP 3710, which is available from The Dow Chemical Company. It is a very fine solid particulate polymer (modified polystyrene latex), which is available as approximately a 50% emulsion in water at a pH of 5.5 and a Brookfield viscosity of<100 mPas. The mean particle size is 0.142 μm, the median particle size is 0.14 μm, the mode of distribution is 0.141 μm, the standard deviation of the distribution is 0.0217 μm and the coefficient of variation 15.29%. The particular shape of the distribution as measured in a Coulter LS series 230 particle size analyser is given in FIG. 3b).

The DPP may be replaced by a SMI-based particulate polymer pigment preferably with a glass transition temperature in the range of 200° C., preferably then a solution of at least 45% solids content, if possible of about 50% solid content, should be used to avoid too high water content of the coating formulation. Mean particle sizes in this case should also be chosen to be around 0.1 μm or up to 0.2 μm.

Alternatively, the particulate pigment may be vacuolated, and may be chosen to be Ropaque BC-643. This is a styrene acrylic polymeric pigment with a 0.6 μm particle size and a 43% void volume. It is available from Rohm and Haas Company, USA. In particular if used for low grammage paper, its content is preferably raised to be 15 parts in dry weight.

Binder Part:

All the coatings according to the invention comprise Acronal 360D, which is available from BASF, DE. It is provided as a 50% aqueous dispersion of a copolymer based upon butylacrylate, styrene and acrylonitile. As a white dispersion it has a pH value of in the range of 7.5 to 8.5 and apparent viscosity (DIN EN ISO 2 555) of 250 to 500 mPas.

The additives comprise brighteners, thickening agents, defoamers etc. Their composition and content can be easily found and adjusted by the person skilled in the art according to the needs arising.

Coating Solution:

The coating solution is applied at a pH of approximately 7 to 9 with a solid content in the range of 60 to 70 at a viscosity as adapted to the particular machine. The conditions of how this coating is applied will be described further below.

Second Layer 2

The various components of the second layer 2 of the 10 examples are listed in table 2. All numbers given are dry or active parts.

TABLE 2
Second Layer composition

| | Mill 1 | Mill 2 | Mill 3 | Pilot 1 |
|---|---|---|---|---|
| Pigment | | | | |
| Century | 25 | 25 | 25 | 25 |
| Setacarb HG | 75 | 75 | 75 | 75 |
| Binder | | | | |
| Latex SB 083 | 11 | 10 | 10 | 11 |
| Additives | 3 | 3 | 3 | 3 |

| | Pilot 2 | Pilot 3 | Pilot 4 | Pilot 5 | Mill 6 |
|---|---|---|---|---|---|
| Pigment | | | | | |
| Century | 25 | 25 | 25 | 25 | |
| Setacarb HG | 75 | 75 | 75 | 75 | 50 |
| CoverCarb75 | | | | | 50 |
| Binder | | | | | |
| Latex SB 083 | 11 | 11 | 11 | 11 | 12 |
| Additives | 3 | 3 | 3 | 3 | 3 |

The examples Mill 4 and Mill 5 have the same second layer composition as Mill 2.

Pigment Part:

Setacarb HG has already been discussed in the context of the top layer. The very fine particle structure of the inorganic pigment Setacarb HG is again one of the important features to obtain the porosity structure according to the invention. It can be shown that the second layer influences the behaviour of the top layer and therefore the use of the fine inorganic pigment in the second layer is advantageous, too.

CoverCarb 75 is a fine ground calcium carbonate available from Omya with a rather steep particle size distribution. Approx. 80% of the particles are smaller than 1 μm. It gives a bright final paper and is cheaper than kaoline, which is why it is useful for replacing the Century part of the pigments.

Apart from the calcium carbonate inorganic pigment, there is, in the case of the coatings according to the invention, also fine kaolin present, namely Century. Century is a kaolin with a slight lamina type structure compared to the above-mentioned Amazon kaolin Century shows a distribution in which more than a 65% of the mass are provided by particles with a diameter of<1 μm, and 47% of the mass are provided by particles with a diameter of<0.6 μm.

Binder Part:

Rhodopas SB 083 is a styrene butadiene latex emulsion in water with a solid content of approximately 50% and a pH value of approximately 5.5. It is available from Rhodia, FR.

The additives comprise brighteners, thickening agents, defoamers etc. Their composition and content can be easily found and adjusted by the person skilled in the art according to the needs arising.

Third Layer 3

The various components of the third layer 3 of the 10 examples are listed in table 3. All numbers given are dry or active parts.

TABLE 3
third Layer composition.

| | Mill 1 | Mill 2 | Mill 3/6 | Pilot 1 |
|---|---|---|---|---|
| Pigment | | | | |
| HC 75 | 30 | 30 | 30 | 30 |
| HCover Carb | 70 | 70 | 70 | 70 |
| Binder | | | | |
| Latex SB 083 | 8 | 8 | 8 | 8 |
| Additives | 5.7 | 5.7 | 5.7 | 5.7 |
| | Pilot 2 | Pilot 3 | Pilot 4 | Pilot 5 |
| Pigment | | | | |
| HC 75 | 30 | 30 | 30 | 30 |
| HCover Carb | 70 | 70 | 70 | 70 |
| Binder | | | | |
| Latex SB 083 | 8 | 8 | 8 | 8 |
| Additives | 5.7 | 5.7 | 5.7 | 5.7 |

The examples Mill 4 and Mill 5 have the same third layer composition as Mill 2.

Pigment Part:

The particle size distribution of Cover Carb 75 is displayed in FIG. 2, it's a fine ground particulate calcium inorganic pigment. Hydrocarb HC 75 is a calcium carbonate inorganic pigment. Approx. 50% of the particles of this pigment are smaller than 1 μm and approx. 30% of the particles are smaller than 0.5 μm.

As concerns the binder part also here, the additives comprise brighteners, thickening agents, defoamers etc. Their composition and content can be easily found and adjusted by the person skilled in the art according to the needs arising.

Application of the Coatings

On the substrate 5, which may be a standard fibrous paper web, first a sizing layer is usually applied using standard coating techniques (preferentially blade but also contactless methods are possible). Also the coatings yielding the third layer 3 and the second layer 2 are being applied to the substrate using standard coating techniques (preferentially blade). Between the different coating processes, no calendering is usually necessary. For none of the coatings given in the examples calendering has been used between the application of the coatings. The conditions for the application of the top coating, the top layer 1, are summarised for the 10 examples together with the calendering conditions in table 4. In principle also for the top layer, standard coating techniques are used:

TABLE 4
Processing parameters for top layer

| | | Mill 1 | Mill 2 | Mill 3 | Pilot 1 |
|---|---|---|---|---|---|
| blade | | rigid | rigid | rigid | bent |
| application | g · m−2 | 8 | 8 | 8 | 8 |
| mass | bd | | | | |
| drying | kind | ir/af/cil | ir/af/cil | ir/af/cil | ir/af/cil |
| speed | m/min | 1200 | 1150 | 1050 | 900 |
| filtering | μm | 150 | 150 | 150 | 80 |
| coating | | | | | |
| S-calender | N/mm | 110 | 110 | 110 | 110 |
| load | | | | | |
| nips | nips/ | 3/8 | 2/6 | 3/8 | 2/11 |
| | rolls | | | | |
| speed | m/min | 800 | 800 | 800 | 300 |
| temperature | ° C. | 60 | 60 | 60 | 60 |

| | | Pilot 2 | Pilot 3 | Pilot 4 | Pilot 5 | Mill 6 |
|---|---|---|---|---|---|---|
| blade | | bent | bent | rigid | rigid | rigid |
| application | g · m−2 | 8 | 8 | 9 | 9 | 7-7.5 |
| mass | bd | | | | | |
| drying | kind | ir/af/cil | ir/af | ir/af | ir/af | ir/af/cil |
| speed | m/min | 900 | 900 | 1600 | 1600 | 1100 |
| filtering | μm | 80 | 80 | 80 | 80 | 150 |
| coating | | | | | | |
| S-calender | N/mm | 110 | 110 | 110 | 110 | 110 |
| load | | | | | | |
| nips | nips/ | 2/11 | 2/11 | 2/7 | 2/7 | 3/8 |
| | rolls | | | | | |
| speed | m/min | 300 | 300 | 300 | 300 | 800 |
| temperature | ° C. | 60 | 60 | 60 | 60 | 90 |

Processing of Mill 4 and Mill 5 is identical to processing of Mill 2.

In the context of the drying step, ir stands for infra red, af stands for air foil, and cil stands for internally heated drying cylinder. Bd stands for bone dry. As one can see, the web is being coated at high speeds of usually above 900 m/min. In case of the nips, e.g. 2/8 stands for a stack of 8 rolls, only 2 nips of which is being used.

If calendering is carried out, it is under very soft conditions, i.e. temperatures of the rolls are kept at approximately 60 degree Celsius (usually according to the state of the art more than 80 degree are necessary for achieving the gloss) and the load on the calendering rolls as well as their number is also kept low, namely the S-calender load is about 110 N/mm using only 2 or 3 nips, while typical values for glossy paper according to the state-of-the-art are in the range of more than 230 N/mm normally using 10 Nips.

Properties of the Resulting Printing Paper

FIG. 4 shows SEM pictures using a magnification factor of 40,000× of the coatings of some of the examples (a Mill 2, b: Pilot 1, c: Pilot 2, d: Pilot 3) as well as of the comparative example. Clearly it can be seen from these pictures, that the coating according to the invention (FIGS. 4a-d) show a very particular surface structure, which is much finer, and in particular in the cases, where the organic pigment is present (FIGS. 4a,b,d), one can recognise the very small sphere-shaped organic pigment particles embedded between the randomly shaped particles of the inorganic pigment. But also in the case where there is no organic pigment present (FIG. 4c) a much finer and more porous structure is observed. From a purely visual point of view it is already apparent that there is a large difference between a coating according to the state-of-the-art (comparative example) and a coating according to the present invention, the difference being the much finer porous structure present in the coatings according to the invention. Generally one can therefore say that it is an intention of this disclosure to get protection for a surface structure as visible in one of the FIGS. 4a-d independent of the underlying method of manufacturing and the underlying materials. The SEM pictures have been taken using the following SEM apparatus: Philips type SEM 501B at a magnification of 40,000×.

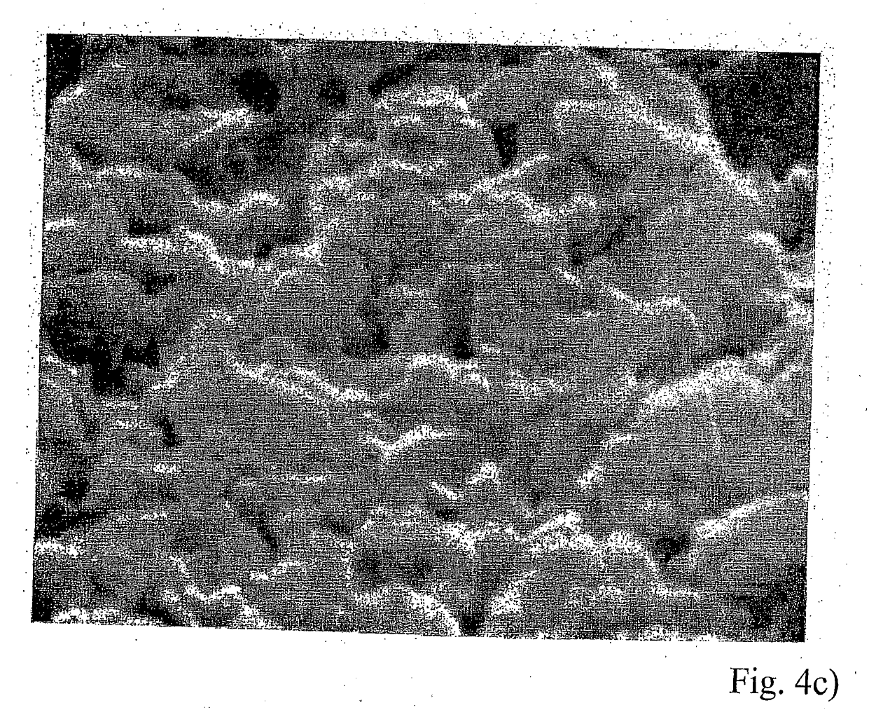

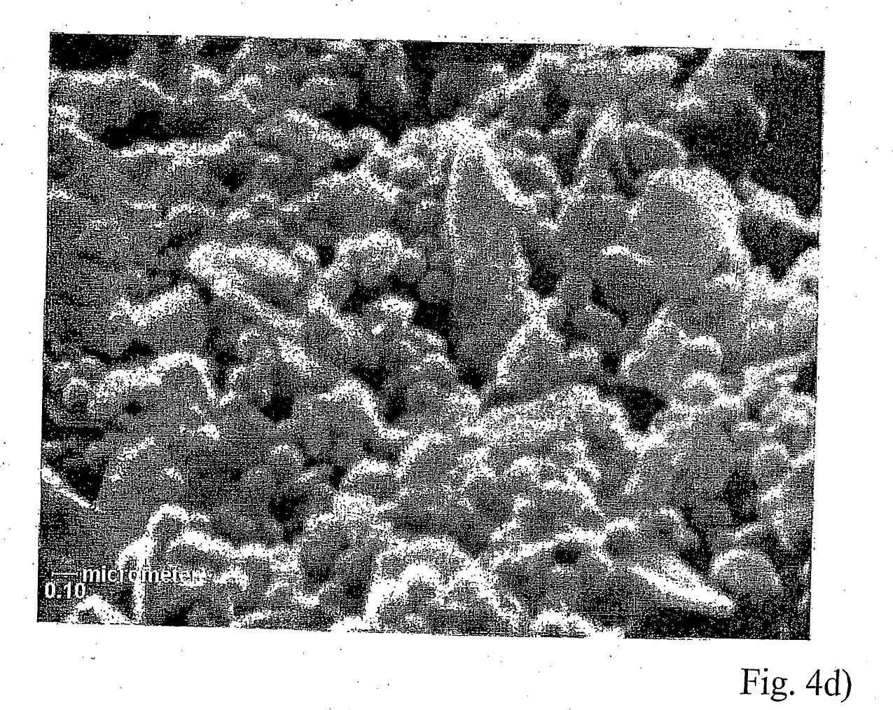

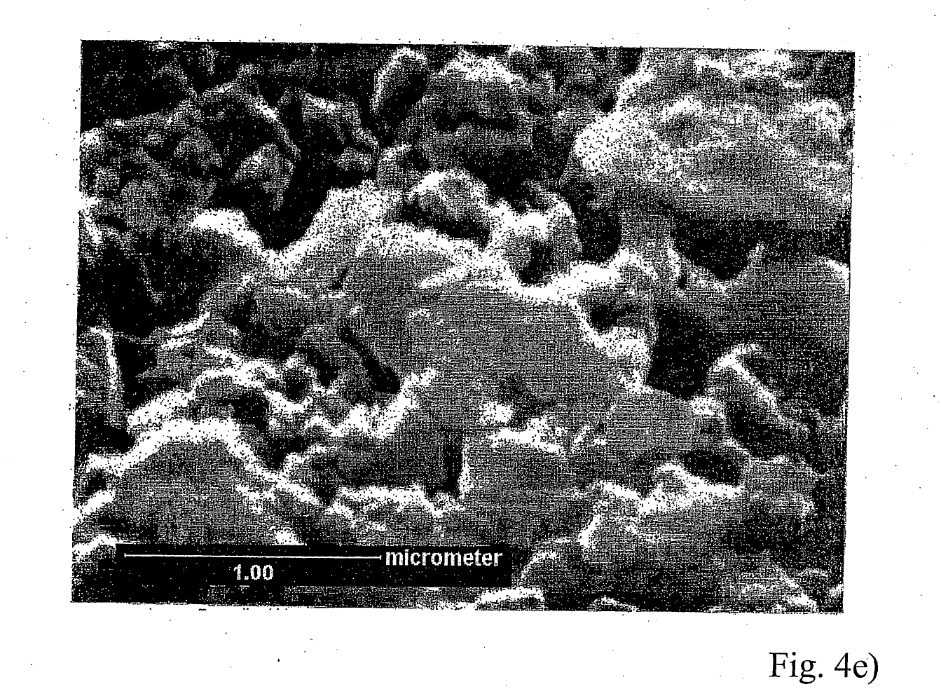

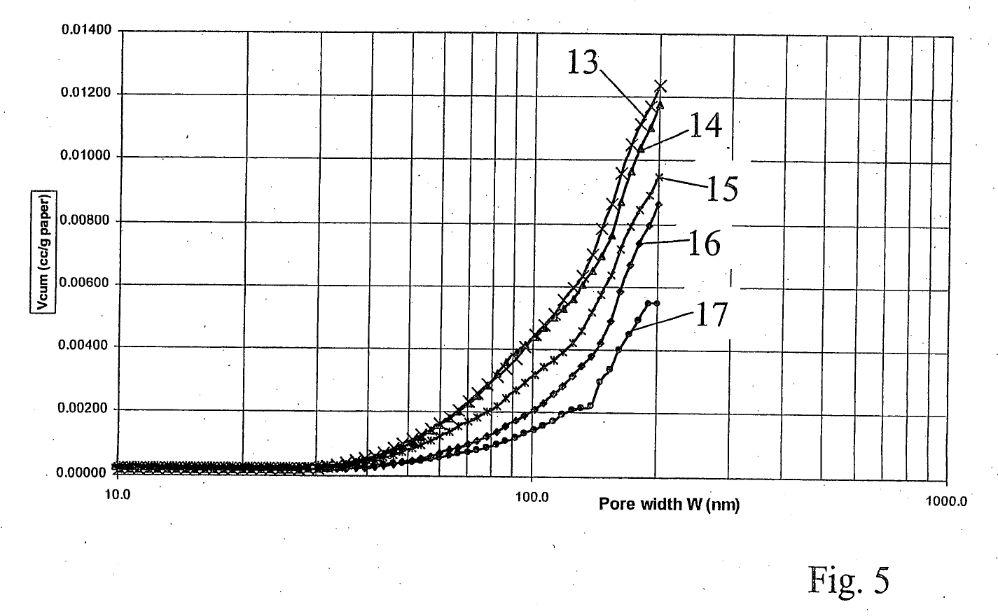

To quantify this particular structure, FIG. 5 shows cumulative porosity in cm³/g (paper) as a function of the pore width as measured by liquid nitrogen intrusion measurements. 13 indicates example Mill 2, 14 to 16 indicate Pilot 1, Pilot 2 and Pilot 3, respectively and 17 indicates the comparative example. Clearly visible is the very large difference in cumulative accessible pore volume of pores that are smaller than, for example, 100 nm, or smaller than 150 nm or smaller than 200 nm. This porosity seems to be key to the possible ink set-off behaviour. The porosity has been measured using a liquid nitrogen intrusion porosity analyser as available from Micromeritics, USA type ASAP 2400, measuring temperature: 77 degrees Kelvin.

The properties of the paper shall be further illustrated by listing the the various examples in table 5:

TABLE 5
Properties of the examples and of the comparative example.

| | Mill 1 | | Mill 2 | | Mill 3 | | Mill 4 | | Mill 5 | |
|---|---|---|---|---|---|---|---|---|---|---|
| | ws | fs | ws | fs | ws | fs | ws | fs | ws | fs |
| analysis R&D | | | | | | | | | | |
| base paper (g/m2) | NA | | 98.4 | | NA | | NA | | NA | |
| coated paper (g/m2) | 116.4 | | 113.9 | | 113.8 | | 116 | | 115 | |
| Thickness (μm) | 91 | | 95.7 | | 96 | | NA | | NA | |
| roughness PPS (μm) | 0.66 | 0.63 | 0.90 | 0.99 | 0.87 | 0.88 | 0.82 | 0.87 | 0.91 | 0.82 |
| Tappi 75° gloss (%) | 78.9 | 82.9 | 76.4 | 76 | 78.7 | 77.4 | 76 | 76 | 76 | 75 |
| DIN 75° gloss (%) | 56.8 | 63.5 | 50.9 | 48.3 | 50.4 | 48.5 | 51 | 52 | 44 | 47 |
| DIN 45° gloss (%) | 17.3 | 27.9 | 16.4 | 15.6 | 17.5 | 17.3 | NA | NA | NA | NA |
| Tappi 75° print gloss (%) | 78.6 | 79.6 | 77.1 | 80.2 | 80.3 | 80.6 | NA | NA | NA | NA |
| DIN 75° print gloss (%) | 36.6 | 38.6 | 37.5 | 40.3 | 34.5 | 35.2 | NA | NA | NA | NA |
| DIN 45° print gloss (%) | 21.1 | 23.9 | 22 | 24.8 | 20.2 | 21 | NA | NA | NA | NA |
| volume (cm 3/g) | 0.85 | | 0.84 | | 0.84 | | 0.86 | | 0.85 | |
| set-off Skinnex 800 | | | | | | | | | | |
| 15 sec | 0.68 | 0.66 | 0.46 | 0.54 | 0.39 | 0.51 | 0.42 | 0.34 | 0.51 | 0.49 |
| 30 sec | 0.35 | 0.32 | 0.07 | 0.11 | 0.16 | 0.13 | 0.27 | 0.20 | 0.16 | 0.18 |
| 60 sec | 0.1 | 0.08 | 0.01 | 0.01 | 0.03 | 0.03 | 0.09 | 0.09 | 0.01 | 0.02 |
| 120 sec | 0.04 | 0.03 | 0 | 0 | 0.01 | 0.01 | 0.03 | 0.01 | 0.00 | 0.00 |
| | Pilot 1 | | Pilot 2 | | Pilot 3 | | Pilot 4 | | Pilot 5 | |
| | ws | fs | ws | fs | ws | fs | ws | fs | ws | fs |
| analysis R&D | | | | | | | | | | |
| base paper | | | | | | | | | | |
| coated paper (g/m2) | 118.1 | | 120.0 | | 117.8 | | 116.3 | | 126.0 | |
| Thickness (μm) | 95 | | 95 | | 96 | | 92 | | 93 | |
| roughness PPS (μm) | 0.70 | 0.81 | 0.79 | 1.22 | 0.74 | 0.9 | 0.68 | 0.71 | 0.58 | 0.62 |
| Tappi 75° gloss (%) | 83.8 | 83.4 | 75.1 | 75.1 | 80.1 | 80.3 | 79.7 | 80.8 | 78.8 | 81 |
| DIN 75° gloss (%) | 60.5 | 56.3 | 53.1 | 50.7 | 58.0 | 56.7 | 56.3 | 48.7 | 59.7 | 53.1 |
| DIN 45° gloss (%) | 27.3 | 22.2 | 15.7 | 13.3 | 21.6 | 18.9 | 19.7 | 17.0 | 20.0 | 17.3 |
| Tappi 75° print gloss (%) | 88.6 | 88.5 | 89.5 | 89.3 | 90.7 | 90.9 | 84.2 | 83.5 | 83.2 | 83.6 |
| DIN 75° print gloss (%) | 48.4 | 46.6 | 49.5 | 47.1 | 49.9 | 48.8 | 36.4 | 29.5 | 37.6 | 37.1 |
| DIN 45° print gloss (%) | | | | | | | 21.4 | 16.4 | 22.4 | 22.4 |
| set-off Skinnex 800 | | | | | | | | | | |
| 15 sec | 0.66 | 0.71 | 0.97 | 0.95 | 1.15 | 1.33 | 0.65 | 0.64 | 0.63 | 0.94 |
| 30 sec | 0.27 | 0.36 | 0.43 | 0.49 | 0.54 | 0.62 | 0.23 | 0.22 | 0.25 | 0.20 |
| 60 sec | 0.05 | 0.05 | 0.12 | 0.18 | 0.11 | 0.15 | 0.03 | 0.03 | 0.03 | 0.06 |
| 120 sec | 0.01 | 0.01 | 0.01 | 0.02 | 0.02 | 0.02 | 0.01 | 0.01 | 0.0 | 0.02 |

| | |
|---|---|
| Comparative | |
| example | Mill 6 |

| | ws | fs | ws | |
|---|---|---|---|---|
| analysis R&D | | | | |
| base paper | | | | |
| coated paper (g/m2) | 117.5 | | 116.1 | |
| Thickness (μm) | 86 | | 100 | |
| roughness PPS (μm) | 0.74 | 0.78 | 0.73 | 0.69 |
| Tappi 75° gloss (%) | 75.2 | 73.0 | 69.5 | 70.8 |
| DIN 75° gloss (%) | 53.9 | 48.5 | 49 | 49.9 |
| DIN 45° gloss (%) | 19.2 | 15.7 | 12.6 | 14.1 |
| Tappi 75° print gloss (%) | 81.5 | 81 | 85.3 | 83.6 |
| DIN 75° print gloss (%) | 40.1 | 39.9 | | |
| DIN 45° print gloss (%) | 22.9 | 21.2 | | |
| set-off Skinnex 800 | | | | |
| 15 sec | 0.82 | 0.67 | 0.5 | 0.56 |
| 30 sec | 0.44 | 0.38 | 0.14 | 0.18 |
| 60 sec | 0.13 | 0.1 | 0.01 | 0.01 |
| 120 sec | 0.02 | 0.01 | 0 | 0 |

WS stands for wire side, FS for felt side of the example. NA indicates that these values have not been measured.

For comparison for all the experiments papers have been used with a paperweight of approximately 115 g/m². The scope of the invention is however not limited to this weight. As can already be seen from the thickness of the resulting paper in μm, there is a significant difference between the comparative example and the other examples according to the invention, in that at the same paperweight the papers according to the invention are thicker than the comparative example. This is correspondingly also reflected in the volume as indicated in cm³/g, which is the inverse of the density and stands for the bulk. The volume of the examples according to the invention is generally larger than the one of the comparative example, the bulk is therefore superior to the state-of-the-art.

When looking at the roughness in PPS (Parker Print Surface values) in μm, almost all examples are within the target values, which is that PPS should be smaller than 1 μm.

Also the gloss values, for which targets had been defined as TAPPI 75 Deg larger than 75% and DIN 75 Deg larger than 45% can be met in spite of the little calendering for all examples. Generally gloss is superior to the comparative example. Gloss has been measured using the following gloss analyzer: Lehman type LGDL-05.3/LTML-01.

What strikes most is the superior set-off behaviour of the ink as measured using a model ink type Skinnex 800 (Pruefbau printability testing equipment for e.g. measuring set-off behaviour). Generally for a time of 30 sec the target is to have set-off of less than 0.30. Apparently, this is not the case for some of the examples listed in table 5, the reason being the different binder (latex) content. The binder content can be used for adjusting the set-off of the ink. The more binder is present in the top coating, the less non-polar the surface becomes in spite of the fact that the porosity remains roughly the same as far as it can be measured with the methods presented here. However, if the surface becomes too polar, the usually non-polar offset inks cannot enter the pores anymore, thus giving rise to larger set-off values.

As usually additionally surfactants are being present in the latex dispersions for stabilizing these dispersions, the above-mentioned effect of rendering of the surface more polar may also be caused by these surfactants at least partially.

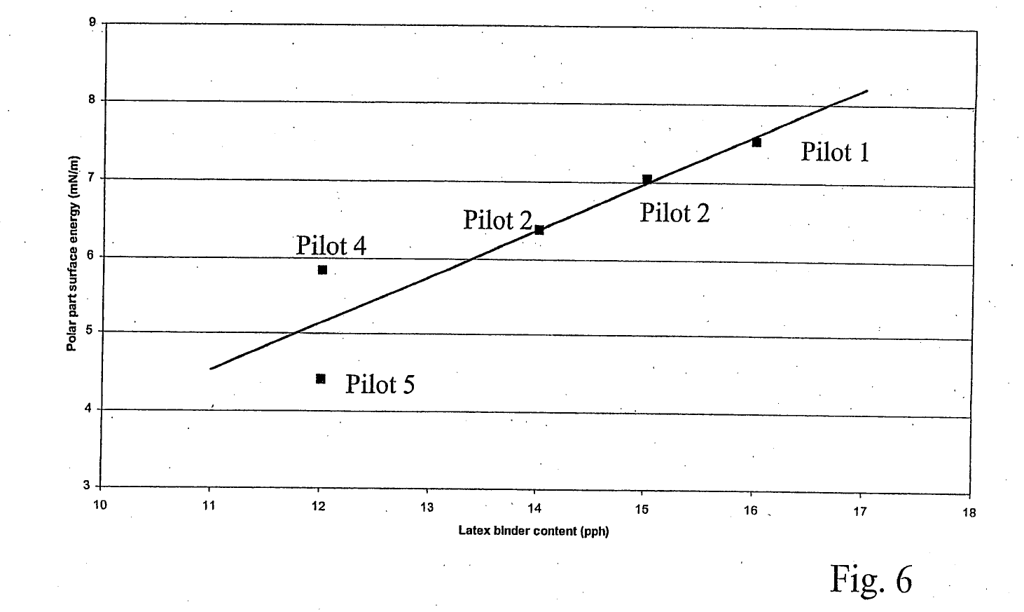

The relation between the polarity of the surface and the latex binder content is displayed in FIG. 6, and one can clearly see that the higher the latex binder content, the higher the polar part of the surface energy. A linear relationship between these two quantities has been found. Correspondingly, the higher the polar part of the surface energy, the less easy for a non-polar offset ink to enter the pores. The data of FIG. 6 have been measured using a Fibrodat analyzer (Fibrodat analyzer: Fibro Systems AB, Sweden, type Data 1100).

Generally all examples show good printing behaviour, i.e. good pick resistance, low mottle, low burnishing, etc.

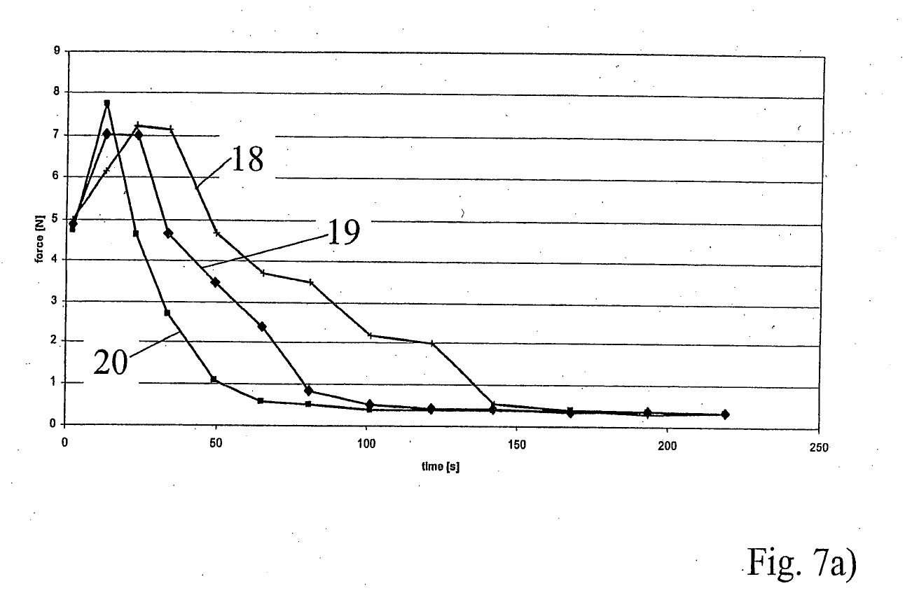

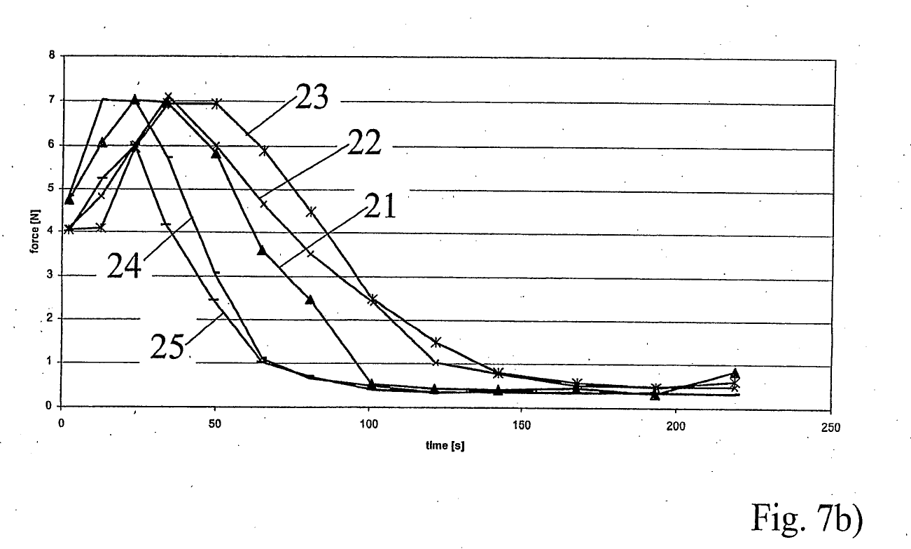

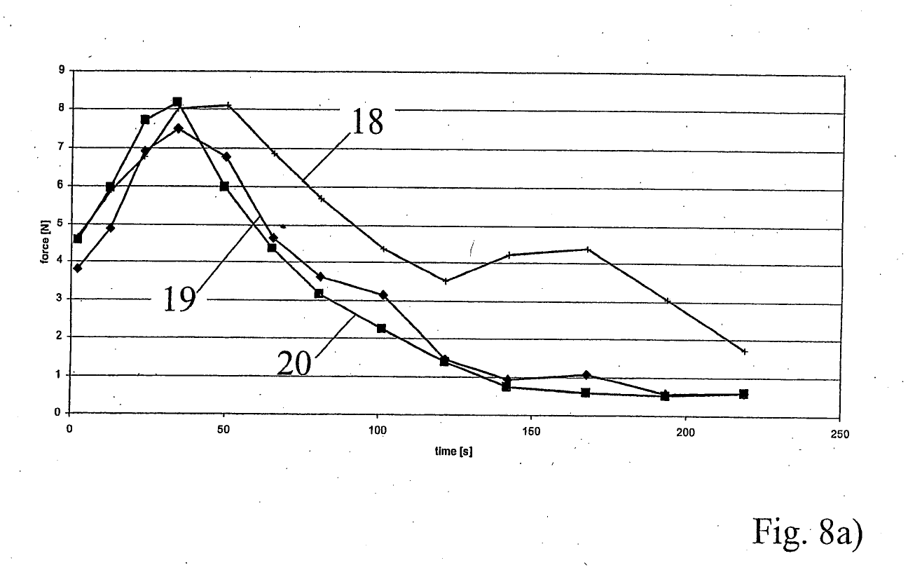

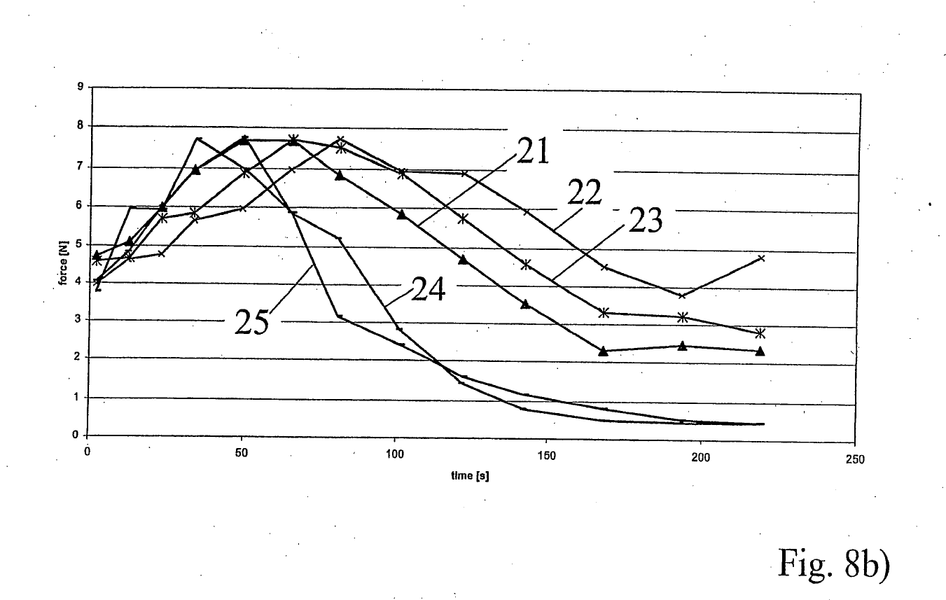

To support this finding, in FIGS. 7 and 8 additionally tack measurements are shown for mineral oil (FIG. 7) based ink and for biological ink oil based ink (FIG. 8). In case of tack measurements, one is measuring the final sum of three forces of ink as f(time), when ink is gradually being sucked up in the paper coating: adhesion of ink at feeding roll, cohesion in ink and adhesion of ink at paper. Adhesion and cohesion are clearly related to surface energy and viscosity properties. Ink components are pigment+resin and an oil carrier system, consisting of mineral (=relatively non-polar) and biological (=relatively polar) oil. Tests with two model inks have been conducted, one only having mineral oil as carrier (FIG. 7) and one having only biological oil (FIG. 8). In the graphs one can see a difference in behaviour between on the one side papers of one series (FIGS. 7b and 8b) Pilot 4 and Pilot 5 (less binder Acronal S360 D=relatively polar) vs. Pilot 1, Pilot 2, Pilot 3 (much more binder) and on the other side papers of the other series (FIG. 7a and 8a) Mill 2 and Mill 3 (less binder) vs. Mill 1 (much binder): with much binder the graphs are always clearly ‘slower’ than with less binder, the differences being even clearly bigger in case of biological oil. Tack has been measured using the following tack apparatus: Ink/Surface Interaction tester, Segan Ltd.

The more latex is present in the coating, the higher the polar constituent of the surface energy is.

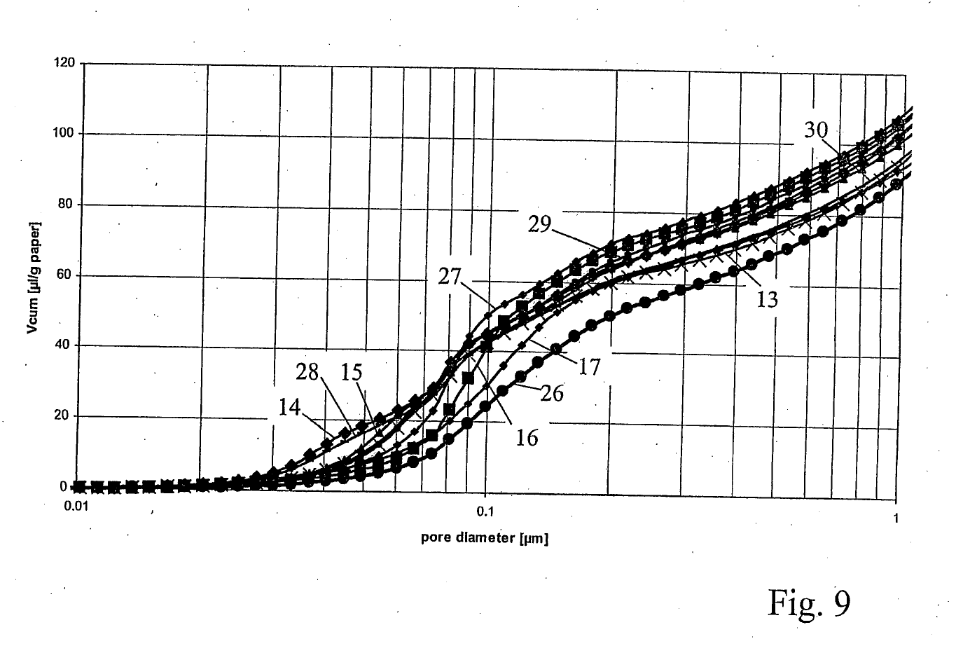

For the sake of comparison, FIG. 9 displays mercury intrusion porosity measurements of the examples as well as of the comparative example and of a substrate with a sizing layer and a third layer. Mercury intrusion measurement of porosity is different from the above-mentioned liquid nitrogen intrusion measurement, as much more pressure is being applied in particular in the range where pore diameters of less than 1 μm are being measured. Correspondingly, the paper being stressed more heavily in this region, the results differ from the ones obtained with liquid nitrogen measurements. However, as can be seen from FIG. 9, the porosity characteristics of the uncoated substrate 26 is substantially different from the characteristics of the coated papers. Additionally, the comparative example 17 clearly shows a cumulative porosity below 0.1 μm which is substantially below the ones of the examples 28 (Mill 1), 13 Mill 2), 30 (Mill 3), 14 (Pilot 1), 15 (Pilot 2), 16 (Pilot 3), 29 (Pilot 4) and 25 (Pilot 5). When characterising the paper according to the present invention using mercury intrusion measurements as a reference, they could be characterised as papers with a cumulative porosity for pores sizes up to 100 nm of more than 30 μl/g (Paper), or even with cumulative porosity for pores sizes up to 100 nm of more than 40 μl/g (Paper), when using mercury intrusion measurements. Also clearly visible from FIG. 9 is the fact that the presence of binder does not measurably change the porosity characteristics substantially in this region of small pores. This can for example be seen when comparing the example Pilot 3 designated with a reference numeral 15 which has a DPP 3710 content of 10 parts while having a binder content of 15 parts, with Mill 2, Mill 3 or Pilot 4, designated with reference numerals 13, 30 and 24, respectively which all have a DPP 3710 content of 10 parts and a binder content of 11 to 12 parts. Mercury intrusion porosity has been measured using a Hg-intrusion porosity analyzer: Quecksilberporosimeter Micromeritics AutoPore IV 9500.

### LIST OF REFERENCE NUMERALS

1 top layer
2 second layer
3 third layer
4 sizing layer
5 substrate
6 first side of the printing sheet/substrate
7 Setacarb HG
9 CC75 (Cover Carb)
12 Amazon
13 Mill 2
14 Pilot 1
15 Pilot 3
16 Pilot 2
17 Comparative example
18 Mill 1 (Tack mineral ink oil)
19 Mill 2 (Tack mineral ink oil)
20 Mill 3 (Tack mineral ink oil)
21 Pilot 1 (Tack mineral ink oil)
22 Pilot 2 (Tack mineral ink oil)
23 Pilot 3 (Tack mineral ink oil)
24 Pilot 4 (Tack mineral ink oil)
25 Pilot 5 (Tack mineral ink oil)
26 substrate with sizing layer and third layer only
27 Pilot 5
28 Mill 1
29 Pilot 4
30 Mill 3

1. A printing sheet comprising a substrate and, on at least one side of the substrate, an image receptive coating layer with a cumulative porosity volume of pore widths below 200 nm as measured using nitrogen intrusion methods of more than 0.006 cm³ per gram paper.

2. Printing sheet according to claim 1, characterised in that the cumulative porosity volume of pore widths below 200 nm is more than 0.008 cm³ per gram paper.

3. Printing sheet according to one of the preceding claims, characterised in that the surface of the image receptive layer is substantially non-polar.

4. Printing sheet according to claim 3, characterised in that the polar part of the surface energy of the surface of the image receptive layer is less than 7 mN/m, preferably less than 6 mN/m as determined by contact angle measurements at a Parker Print Surf (PPS) surface roughness of between 0.8 and 1, preferably of less than 0.9 μm wherein preferentially the polar part of the surface energy of the surface of the image receptive layer is more than 4 mN/m.

5. Printing sheet according to one of the preceding claims, characterised by a gloss on the surface of the image receptive coating of more than 75% according to TAPPI 75 deg.

6. Printing sheet according to one of the preceding claims, characterised by a gloss on the surface of the image receptive coating of more than 45, preferably more than 50 according to DIN 75 deg.

7. Printing sheet according to one of the preceding claims, characterised in that an image receptive coating layer is provided on the both sides of the substrate.

8. Printing sheet according to one of the preceding claims, characterised in that it has a specific volume of more than 0.8 cm³/g, preferably of more than 0.82 or 0.85 cm³/g.

9. Printing sheet according to one of the preceding claims, characterised by an ink set-off of less than 0.3 at 30 secs, preferably of in the range of between 0.15 to 0.25 or of approx. 0.2 at 30 seconds.

10. Printing sheet according to one of the preceding claims, characterised in that the image receptive coating layer comprises a top layer (1) comprising:
a pigment park wherein this pigment part is composed of
a) 50 to 100 parts in dry weight of a fine particulate carbonate with a particle size distribution such that more than 80% of the particles are smaller than 1 μm, preferably with a particle size distribution such that approximately 90% of the particles are smaller than 1 μm,
b) 0 to 50 parts in dry weight of a fine particulate kaolin with a particle size distribution such that more than 90% of the particles are smaller than 1 μm, preferably with a particle size distribution that more than 95% of the particles are smaller than 1 μm,
c) 0 to 20 parts or up to 30 parts in dry weight of a particulate, preferably solid or vacuolated polymer pigment with a particle size distribution such that more than 90% of the particles are smaller than 0.5 μm preferably with a particle size distribution such that 90% of the particles have sizes between 0.05 and 0.3 μm, in particular between 0.1 and 0.2 μm, or in the case of a vacuolated polymer pigment also with a mean particle see of about 0.6 μm,
and a binder part, wherein this binder part is composed of:
a′) less than 12 to 16 parts in dry weight of binder and
b′) less than 2 parts in dry weight of additives.

11. Printing sheet according to one of the preceding claims, characterised in that the image receptive coating layer comprises a top layer (1) comprising:
a pigment part wherein this pigment part is composed of
a) 0 to 50 parts in dry weight of a fine particulate carbonate with a particle size distribution such that more than 80% of the particles are smaller than 1 μm, preferably with a particle size distribution such that approximately 90% of the particles are smaller than 1 μm,
b) 0 to 50 parts in dry weight of a fine particulate kaolin with a particle size distribution such that more than 90% of the particles are smaller than 1 μm, preferably with a particle size distribution that more than 95% of the particles are smaller than 1 μm,
c) 2 to 100 parts in dry weight of a particulate solid polymer pigment with a particle size distribution such that more than 90% of the particles are smaller than 0.5 μm, preferably with a particle size distribution such that 90% of the particles have sizes between 0.05 and 0.3 μm, in particular between 0.1 and 0.2 μm,
and a binder part, wherein this binder part is composed of:
a′) less than 12 to 16 parts in dry weight of binder and
b′) less than 2 parts in dry weight of additives.

12. Printing sheet according to claim 10, characterised in that pigment part of the top layer (1) comprises
a) 60 to 100 parts in dry weight, preferably 65 to 80 parts in dry weight of a fine particulate calcium carbonate with a particle size distribution such that approximately 90% of the particles are smaller than 1 μm,
b) 10 to 40 parts in dry weight, preferably 15 to 30 parts in dry weight of a fine particulate kaolin with a particle size distribution such that 95% of the particles are smaller than 1 μm,
c) 10 to 15 parts in dry weight of a solid particulate polymer pigment with a particle size distribution centred at approximately 0.13 to 0.17 μm, preferably centred at approximately 0.14 μm, wherein 95% of the particles are located within+/−0.03 μm of this mean particle size.

13. Printing sheet according to one of the claims 10 or 12, characterised in that the solid particulate polymer pigment (c) is selected from the group consisting of: poly(methyl methacrylate), poly(2-chloroethyl methacrylate), poly(isopropyl methacrylate), poly(phenyl methacrylate), polyacrylonitrile, polymethacrylonitrile, polycarbonates, polyetheretherketones, polyimides, acetals, polyphenylene sulfides, phenolic resins, melamine resins, urea resins, epoxy resins, polystyrene latexes, polyimides, and alloys, blends, mixtures and derivatives thereof.

14. Printing sheet according to one of the claims 10 to 13, characterised in that the solid particulate polymer pigment (c) is a modified polystyrene latex.

15. Printing sheet according to one of the claims 10 to 14, characterised in that the solid particulate polymer pigment (c) is based on styrene maleic acid copolymeric latexes (SMA) and/or styrene malimide copolymeric latexes (SMI), preferably based almost exclusively on styrene malimide copolymeric latexes (SMI) with glass transition temperatures in the range of 200° C.

16. Printing sheet according to one of the claims 10 to 15, characterised in that the binder part of the top layer (1) comprises
a′) a binder selected from the group consisting of latex, in particular styrene-butadiene, styrene-butadiene-acrylonitrile, styrene-acrylic, styrene-butadiene-acrylic latexes, starch, polyacrylate salt, polyvinyl alcohol, soy, casein, carboxymethyl cellulose, hydroxymethyl cellulose and mixtures thereof,
b′) additives like defoamers, colorants, brighteners, dispersants, thickeners, water retention agents, preservatives, crosslinkers, lubricants and pH control agents.

17. Printing sheet according to claim 16, characterised in that the binder is an acrylic ester copolymer based on butylacrylate, styrene and acrylonitrile.

18. Printing sheet according to one of the claims 16 to 17, characterised in that 10 to 16 parts in dry weight, preferably 11 to 14 parts in dry weight of binder (a′) is present in the binder part.

19. Printing sheet according to one of the claims 10 to 18, characterised in that the top layer (1) has a total dried coat weight of in the range of 3 to 25 g/m², preferably in the range of 4 to 15 g/m², and most preferably of about 6 to 12 g/m².

20. Printing sheet according to one of the claims 10 to 19, characterised in that the image receptive coating layer has a second layer (2) beneath said top layer (1) comprising:
a pigment part, wherein this pigment part is composed of
A) 50 to 100 parts in dry weight of a fine particulate carbonate with a particle size distribution such that more than 80% of the particles are smaller than 1 μm, preferably with a particle size distribution such that approximately 90% of the particles are smaller than 1 μm,
B) 0 to 50 parts in dry weight of a fine particulate kaolin with a particle size distribution such that more than 50% of the particles are smaller than 1 μm, preferably with a particle size distribution that more than 60% of the particles are smaller than 1 μm, or alternatively of a fine particulate carbonate with a particle size distribution such that more than 70% of the particles are smaller than 1 μm,
and a binder part, wherein this binder is composed of:
A′) less than 20 parts in dry weight of binder and
B′) less than 4 parts in dry weight of additives.

21. Printing sheet according to claim 20, characterised in that the pigment part of the second layer (2) comprises
A) 70 to 90 parts in dry weight, preferably approx. 75 parts in dry weight of a fine particulate calcium carbonate with a particle size distribution such that approximately 90% of the particles are smaller than 1 μm,
B) 20 to 40 parts in dry weight, preferably approx. 25 parts in dry weight a fine particulate kaolin with a particle size distribution such that 65% of the particles are smaller than 1 μm or alternatively 50 to 70 parts of a fine particulate carbonate with a particle size distribution such that more than 70% of the particles are smaller than 1 μm.

22. Printing sheet according to one of the claims 20 to 21, characterised in that the binder part of the second layer (2) comprises
A′) a binder selected from the group consisting of latex, in particular styrene-butadiene, styrene-butadiene-acrylonitrile, styrene-acrylic, styrene-butadiene-acrylic latexes, starch, polyacrylate salt, polyvinyl alcohol, soy, casein, carboxymethyl cellulose, hydroxymethyl cellulose and mixtures thereof,
B′) additives like defoamers, colorants, brighteners, dispersants, thickeners, water retention agents, preservatives, crosslinkers, lubricants and pH control agents.

23. Printing sheet according to claim 22, characterised in that the binder is an acrylic ester copolymer based on butylacrylate and styrene.

24. Printing sheet according to one of the claims 20 to 23, characterised in that 6 to 20 parts in dry weight, preferably 8 to 14 parts in dry weight, and most preferably approximately 10 parts in dry weight of binder is present in the binder part (A′) of the second layer (2).

25. Printing sheet according to one of the claims 20 to 24, characterised in that the second layer (2) has a total dried coat weight of in the range of 5 to 25 g/m², preferably in the range of 8 to 20 g/m².

26. Printing sheet according to one of the claims 20 to 25, characterised in that beneath the second layer (2) there is a third layer (3) which is composed of
a pigment part, wherein this pigment part is composed of
AA) 50 to 100 parts in dry weight of a particulate carbonate with a particle size distribution such that more than 70% of the particles are smaller than 1 μm, preferably with a particle size distribution such that approximately or more than 80% of the particles are smaller than 1 μm,
and a binder part, wherein this binder is composed of:
AA′) less than 10 parts in dry weight of binder and
BB′) less than 4 to 6 parts in dry weight of additives.

27. Printing sheet according to one of the preceding claims, characterised in that its total weight is in the range of 90 or 100 to 250 g/m² or up to 400 g/m².

28. Printing sheet according to one of the preceding claims, characterised in that the substrate (5) is provided with an image receptive coating on both sides.

29. A method of manufacturing a printing sheet comprising:
dd) applying an image receptive top of layer (1) on the substrate said top layer (1) comprising
a pigment part, wherein this pigment part is composed of
a) 50 to 100 part in dry weight of a fine particulate carbonate with a particle size distribution such that more than 80% of the particles are smaller than 1 μm, preferably with a particle size distribution such that approximately 90% of the particles are smaller than 1 μm,
b) 0 to 50 parts in dry weight of a fine particulate kaolin with a particle size distribution such that more than 90% of the particles are smaller than 1 μm, preferably with a particle size distribution that more than 95% of the particles are smaller than 1 μm,
c) 0 to 20 parts or up to 30 parts in dry weight of a particulate, preferably solid or vacuolated polymer pigment with a particle size distribution such that more than 90% of the particles are smaller than 0.5 μm, preferably with a particle size distribution such that 90% of the particles have sizes between 0.05 and 0.3 μm, in particular between 0.1 and 0.2 μm, or in the case of a vacuolated polymer pigment also with a mean particle size of about 0.6 μm, wherein optionally the particulate polymer pigment may replace the inorganic pigments (a,c) completely or partially,
and a binder part, wherein this binder part is composed of:
a′) less than 10 parts in dry weight of binder and
b′) less than 2 parts in dry weight of additives
ee) drying the image receptive coating layer
ff) calendering at a nip pressure of less than 200 N/mm at a temperature of less than 80 degrees Celsius.

30. A method according to claim 29, wherein the top layer (1) has a total dried coat weight of in the range of 3 to 25 g/m², preferably in the range of 4 to 15 g/m², and most preferably of about 6 to 12 g/m².

31. A method according to one of the claims 29 or 20, characterised in an image receptive coating and in particular a top layer according to one of the claims 1 to 17.

32. A method according to one of the claims 29 to 31, characterised in that prior to the application of the top coat layer (1)
cc) a second layer (2) is applied on the substrate, said second layer (2) beneath said top layer (1) comprising preferentially:
a pigment part, wherein this pigment part is composed of
A) 50 to 100 parts in dry weight of a fine particulate carbonate with a particle size distribution such that more than 80% of the particles are smaller than 1 μm, preferably with a particle size distribution such that approximately 90% of the particles are smaller than 1 μm,
B) 0 to 50 parts in dry weight of a fine particulate kaolin with a particle size distribution such that more than 60% of the particles are smaller than 1 μm, preferably with a particle size distribution that more than 70% of the particles are smaller than 1 μm, or alternatively of a fine particulate carbonate with a particle size distribution such that more than 70% of the particles are smaller than 1 μm,
and a binder part, wherein this binder is composed of:
A′) less than 20 parts in dry weight of binder and
B′) less than 4 parts in dry weight of additives.

33. A method according to claim 32, wherein the second layer (2) has a total dried coat weight of in the range of 5 to 25 g/m², preferably in the range of 8 to 20 g/m².

34. A method according to one of the claims 32 or 33, characterised in a second layer (2) according to one of the claims 19 to 24.

35. A method according to one of the claims 32 to 34, characterised in that prior to the application of the second layer (2)
bb) a third layer (3) is applied on the substrate, said third layer (3) beneath said second layer (2) comprising:
AA) 50 to 100 parts in dry weight of a particulate carbonate with a particle size distribution such that more than 70% of the particles are smaller than 1 μm, preferably with a particle size distribution such that approximately or more than 80% of the particles are smaller than 1 μm,
and a binder part, wherein this binder is composed of:
AA′) less than 10 parts in dry weight of binder and
BB′) less than 4 to 6 parts in dry weight of additives.

36. A method according to claim 35, characterised in that prior to the application of the third layer (3) a sizing layer (4) is applied to the substrate (5).

37. A method according to one of the claims 29 to 36, characterised in that the image receptive coating is applied on both surfaces of the substrate (5).

38. A method according to one of the claims 29 to 37, characterised in that the resulting printing sheet has a total weight in the range of 80 to 400 g/m², preferentially of 100 to 250 g/m² after the coating process.

39. A method according to one of the claims 29 to 38, characterised in that in the calendering step (ff) a nip pressure of in the range of 60 to 150 N/mm, preferentially of 90 to approximately 110 N/mm is being used.

40. A method according to one of the claims 29 to 39, characterised in that in the calendering step (ff) a temperature of in the range of 45 to 80 degree Celsius, preferably in the range of 50 to 70 degree Celsius is being used.

41. A method according to one of the claims 29 to 40, characterised in that 4 nips or less are being used in the calendering step (ff).

42. A method according to one of the claims 29 to 41, characterised in that in the calendering step (ff) rolls of steel or fibre surface are being used at a speed of 300 to 1000 m/min.

43. A method according to one of the claims 29 to 41, characterised in that prior to the calendering (ff) of the printing sheet is dried to a moisture of less than 5%.

44. Use of a printing sheet according to one of the claims 1 to 28 in an offset printing process.

45. A printing sheet comprising a substrate and, on at least one side of the substrate, an image receptive coating layer with a cumulative porosity volume of pore widths below 200 nm as measured using nitrogen intrusion methods of more than 0.006 cm³ per gram paper.

45. A printing sheet according to claim 45, characterised in that the cumulative porosity volume of pore widths below 200 nm is more than 0.008 cm³ per gram paper.

47. Printing sheet according to claim 45, characterised in that the surface of the image receptive layer is substantially non-polar with a cumulative porosity volume of pore widths below 200 nm as measured using nitrogen intrusion methods of more than 0.006 cm³ per gram paper.

48. A printing sheet according to claim 47, characterised in that the polar part of the surface energy of the surface of the image receptive layer is less than 7 mN/m, preferably less than 6 mN/m as determined by contact angle measurements at a Parker Print Surf (PPS) surface roughness of between 0.8 and 1 μm.

49. A printing sheet according to claim 45, characterised by a gloss on the surface of the image receptive coating of more than 75% according to TAPPI 75 deg.

50. A printing sheet according to claim 45, characterised by a gloss on the surface of the image receptive coating of more than 45.

51. A printing sheet according to claim 45, characterised in that an image receptive coating layer is provided on the both sides of the substrate.

52. A printing sheet according to claim 45, characterised in that it has a specific volume of more than 0.8 cm³/g, preferably of more than 0.82 or 0.85 cm³/g.

53. A printing sheet according to claim 45, characterised by an ink set-off of less than 0.3 at 30 secs.

54. A printing sheet according to claim 45, characterised in that the image receptive coating layer comprises a top layer (1) comprising:
a pigment part, which comprises:
a) 50 to 100 parts in dry weight of a fine particulate carbonate with a particle size distribution such that more than 80% of the particles are smaller than 1 μm, preferably with a particle size distribution such that approximately 90% of the particles are smaller than 1 μm,
b) 0 to 50 parts in dry weight of a fine particulate kaolin with a particle size distribution such that more than 90% of the particles are smaller than 1 μm, preferably with a particle size distribution that more than 95% of the particles are smaller than 1 μm, and
c) 0 to 20 parts or up to 30 parts in dry weight of a particulate, preferably solid or vacuolated polymer pigment with a particle size distribution such that more than 90% of the particles are smaller than 0.5 μm,
and a binder part, which comprises:
a) less than 12 to 16 parts in dry weight of binder, and
b) less than 2 parts in dry weight of additives.

55. A printing sheet according to claim 45, characterised in that the image receptive coating layer comprises a top layer (1) comprising:
a pigment part, which comprises:
a) 0 to 50 parts in dry weight of a fine particulate carbonate with a particle size distribution such that more than 80% of the particles are smaller than 1 μm,
b) 0 to 50 parts in dry weight of a fine particulate kaolin with a particle size distribution such that more than 90% of the particles are smaller than 1 μm, and
c) 2 to 100 parts in dry weight of a particulate solid polymer pigment with a particle size distribution such that more than 90% of the particles are smaller than 0.5 μm,
and a binder part, which comprises:
a) less than 12 to 16 parts in dry weight of binder, and
b) less than 2 parts in dry weight of additives.

56. A printing sheet according to claim 54, characterised in that said pigment part of the top layer (1) comprises:
a) 60 to 100 parts in dry weight, of a fine particulate calcium carbonate with a particle size distribution such that approximately 90% of the particles are smaller than 1 μm,
b) 10 to 40 parts in dry weight, preferably 15 to 30 parts in dry weight of a fine particulate kaolin with a particle size distribution such that 95% of the particles are smaller than 1 μm, and
c) 10 to 15 parts in dry weight of a solid particulate polymer pigment with a particle size distribution centred at approximately 0.13 to 0.17 μm.

57. A printing sheet according to claim 54, characterised in that the solid particulate polymer pigment (c) is selected from the group consisting of: poly(methyl methacrylate), poly(2-chloroethyl methacrylate), poly(isopropyl methacrylate), poly(phenyl methacrylate), polyacrylonitrile, polymethacrylonitrile, polycarbonates, polyetheretherketones, polyimides, acetals, polyphenylene sulfides, phenolic resins, melamine resins, urea resins, epoxy resins, polystyrene latexes, polyacrylamides, and alloys, blends, mixtures and derivatives thereof.

58. A printing sheet according to claim 54, characterised in that the solid particulate polymer pigment (c) is a modified polystyrene latex.

59. A printing sheet according to claim 54, characterised in that said solid particulate polymer pigment (c) is based on styrene maleic acid copolymeric latexes (SMA) and/or styrene malimide copolymeric latexes (SMI), preferably based almost exclusively on styrene malimide copolymeric latexes (SMI) with glass transition temperatures in the range of 200° C.

60. A printing sheet according to claim 54, characterised in that the binder part of the top layer (1) comprises:
a) a binder selected from the group consisting of latex, in particular styrene-butadiene, styrene-butadiene-acrylonitrile, styrene-acrylic, styrene-butadiene-acrylic latexes, starch, polyacrylate salt, polyvinyl alcohol, soy, casein, carboxymethyl cellulose, hydroxymethyl cellulose and mixtures thereof, and
b) additives like defoamers, colorants, brighteners, dispersants, thickeners, water retention agents, preservatives, crosslinkers, lubricants and pH control agents.

61. A printing sheet according to claim 60, characterised in that the binder is an acrylic ester copolymer based on butylacrylate, styrene and acrylonitrile.

62. A printing sheet according to claim 60, characterised in that 10 to 16 parts in dry weight of binder (a) is present in the binder part.

63. A printing sheet according to claim 54, characterised in that said top layer (1) has a total dried coat weight of in the range of 3 to 25 g/m².

64. A printing sheet according to claim 54, characterised in that the image receptive coating layer has a second layer (2) beneath said top layer (1) comprising:
a pigment part, which comprises:
a) 50 to 100 parts in dry weight of a fine particulate carbonate with a particle size distribution such that more than 80% of the particles are smaller than 1 μm, and
b) 0 to 50 parts in dry weight of a fine particulate kaolin with a particle size distribution such that more than 50% of the particles are smaller than 1 μm,
and a binder part, which comprises:
a) less than 20 parts in dry weight of binder, and
b) less than 4 parts in dry weight of additives.

65. A printing sheet according to claim 64, characterised in that the pigment part of the second layer (2) comprises:
a) 70 to 90 parts in dry weight of a fine particulate calcium carbonate with a particle size distribution such that approximately 90% of the particles are smaller than 1 μm, and
b) 20 to 40 parts in dry weight, of a fine particulate kaolin with a particle size distribution such that 65% of the particles are smaller than 1 μm or alternatively 50 to 70 parts of a fine particulate carbonate with a particle size distribution such that more than 70% of the particles are smaller than 1 μm.

66. A printing sheet according to claim 64, characterised in that the binder part of the second layer (2) comprises:
a) a binder selected from the group consisting of latex, in particular styrene-butadiene, styrene-butadiene-acrylonitrile, styrene-acrylic, styrene-butadiene-acrylic latexes, starch, polyacrylate salt, polyvinyl alcohol, soy, casein, carboxymethyl cellulose, hydroxymethyl cellulose and mixtures thereof, and
b) additives like defoamers, colorants, brighteners, dispersants, thickeners, water retention agents, preservatives, crosslinkers, lubricants and pH control agents.

67. A printing sheet according to claim 66, characterised in that the binder is an acrylic ester copolymer based on butylacrylate and styrene.

68. A printing sheet according to claim 64, characterised in that 6 to 20 parts in dry weight of binder is present in the binder part (A′) of the second layer (2).

69. A printing sheet according to claim 64, characterised in that the second layer (2) has a total dried coat weight of in the range of 5 to 25 g/m².

70. A printing sheet according to claim 64, characterised in that beneath the second layer (2) there is a third layer (3) which comprises:
a pigment part, which comprises:
a) 50 to 100 parts in dry weight of a particulate carbonate with a particle size distribution such that more than 70% of the particles are smaller than 1 μm,
and a binder part, which comprises:
i. less than 10 parts in dry weight of binder, and
ii. less than 4 to 6 parts in dry weight of additives.

71. A printing sheet according to claim 45, characterised in that its total weight is in the range of 90 or 100 to 250 g/m² or up to 400 g/m².

72. A printing sheet according to claim 45, characterised in that the substrate (5) is provided with an image receptive coating on both sides.

73. A method of manufacturing a printing sheet comprising:
a) applying an image receptive top of layer (1) on the substrate, said top layer (1) comprising:
a pigment part, which comprises:
i. 50 to 100 parts in dry weight of a fine particulate carbonate with a particle size distribution such that more than 80% of the particles are smaller than 1 μm,
ii. 0 to 50 parts in dry weight of a fine particulate kaolin with a particle size distribution such that more than 90% of the particles are smaller than 1 μm, and
iii. 0 to 20 parts or up to 30 parts in dry weight of a particulate, wherein optionally the particulate polymer pigment may replace the inorganic pigments (a,c) completely or partially,
and a binder part, which comprises:
A) less than 10 parts in dry weight of binder, and
B) less than 2 parts in dry weight of additives
b) drying the image receptive coating layer, and
c) calendering at a nip pressure of less than 200 N/mm at a temperature of less than 80 degrees Celsius.

74. A method according to claim 73, wherein the top layer (1) has a total dried coat weight in the range of 3 to 25 g/m².

75. A method according to claim 74, characterised in that said image receptive coating comprise a top layer with a cumulative porosity volume of pore widths below 200 nm as measured using nitrogen intrusion methods of more than 0.006 cm³ per gram paper.

76. A method according to claim 73, characterised in that prior to the application of the top coat layer (1)
a second layer (2) is applied on the substrate, said second layer (2) beneath said top layer (1) comprising:
a pigment part, which comprises:
a) 50 to 100 parts in dry weight of a fine particulate carbonate with a particle size distribution such that more than 80% of the particles are smaller than 1 μm, and
b) 0 to 50 parts in dry weight of a fine particulate kaolin with a particle size distribution such that more than 60% of the particles are smaller than 1 μm,
and a binder part, which comprises:
i. less than 20 parts in dry weight of binder, and
ii. less than 4 parts in dry weight of additives

77. A method according to claim 76, wherein the second layer (2) has a total dried coat weight in the range of 5 to 25 g/m².

78. A method according to claim 76 wherein second layer (2) comprises a
pigment part, which comprises:
a) 50 to 100 parts in dry weight of a fine particulate carbonate with a particle size distribution such that more than 80% of the particles are smaller than 1 μm, and
b) 0 to 50 parts in dry weight of a fine particulate kaolin with a particle size distribution such that more than 50% of the particles are smaller than 1 μm,
and a binder part, which comprises:
i. less than 20 parts in dry weight of binder, and
ii. less than 4 parts in dry weight of additives.

79. A method according to claim 76, characterised in that prior to the application of the second layer (2)
a third layer (3) is applied on the substrate, said third layer (3) beneath said second layer (2) comprising:
a) 50 to 100 parts in dry weight of a particulate carbonate with a particle size distribution such that more than 70% of the particles are smaller than 1 μm,
and a binder part, which comprises:
i. less than 10 parts in dry weight of binder, and
ii. less than 4 to 6 parts in dry weight of additives.

80. A method according to claim 79, characterised in that prior to the application of the third layer (3) a sizing layer (4) is applied to the substrate (5).

81. A method according to claim 73, characterised in that the image receptive coating is applied on both surfaces of the substrate (5).

82. A method according to claim 73, characterised in that the resulting printing sheet has a total weight in the range of 80 to 400 g/m².

83. A method according to claim 73, characterised in that in the calendering step (c) a nip pressure of in the range of 60 to 150 N/mm.

84. A method according to claim 73, characterised in that in the calendering step (c) a temperature of in the range of 45 to 80 degree Celsius, preferably in the range of 50 to 70 degree Celsius is being used.

85. A method according to claim 73, characterised in that 4 nips or less are being used in the calendering step (c).

86. A method according to claim 73, characterised in that in the calendering step (c) rolls of steel or fibre surface are being used at a speed of 300 to 1000 m/min.

87. A method according to claim 73, characterised in that prior to the calendering (c) of the printing sheet is dried to a moisture of less than 5%.

88. A method of offset printing comprising use of a printing sheet, a substrate and, on at least one side of the substrate, an image receptive coating layer with a cumulative porosity volume of pore widths below 200 nm as measured using nitrogen intrusion methods of more than 0.006 cm³ per gram paper.
